(19) United States
(12) Patent Application Publication
(10) Pub. No.: US 2023/0044173 A1
(43) Pub. Date: Feb. 9, 2023

(54) SYSTEM AND METHOD FOR PROVIDING MANAGEMENT AND ANALYSIS OF CUSTOMERS GRATITUDE FEEDBACKS

(71) Applicant: Eliahu EFRAT, Lexington, MA (US)

(72) Inventor: Eliahu EFRAT, Lexington, MA (US)

(21) Appl. No.: 17/786,585

(22) PCT Filed: Dec. 28, 2020
(86) PCT No.: PCT/US2020/067096

§ 371 Date: Jun. 17, 2022

Related U.S. Application Data
(60) Provisional application No. 62/954,002, filed on Dec. 27, 2019.

(51) Int. Cl. G06Q 10/06; G06Q 30/00

(52) U.S. Cl. CPC G06Q 10/06398; G06Q 30/01

(57) ABSTRACT

Embodiments of the present disclosure provide methods and systems for providing management of customer gratitude feedbacks received in respect of a customer service catered by a first user to a second user. A plurality of user devices executes, via a server, a gratitude feedback management application that displays predefined categories of the customer gratitude feedbacks. The second user is prompted to select at least one predefined category of the customer gratitude feedbacks and send it to the first user, via the respective user devices. The received customer gratitude feedbacks are analyzed and subsequently, at least one award badge is assigned to the first user and the second user. The assigned award badge may be added to the respective user profile of the first user for future use in the career growth of the first user.

### TECHNICAL FIELD

The present invention relates to management and analysis of individual customer gratitude and/or positive feedbacks (referred to as gratitude feedbacks from here on and in the drawings) being received by a service provider person (referred to as service provider from hereon).

### BACKGROUND

Many employees working in customer facing jobs give good service, do their job well, contribute to their customers' experience, and to the company they work for, and therefore they may want to be recognized and show it in their social circle and present their achievements to everyone. They may want to present their great level of service to their friends, to their family, to the public, and to their employer. They may want to build and maintain their service level portfolio/history, which would go with them wherever they go, from job to job and from employer to employer.

In any industry where customer facing service is central, customers are often asked to leave feedback about their experiences with respect to the services they received. Positive feedback from happy customers not only provides satisfaction to the service providers, but also motivates them to continue providing their best services to their customers. Particularly, individual staff or personnel, who are working for a company or organization, and tending to customers on a daily basis, often look forward to receiving positive feedback from their customers. Many a times, positive feedback from various consumers or customers is acknowledged by the organization/management in terms of rewards, awards, perks or promotion for the working staff. The service providing staff members or the working staff members, may thereby build a good track record of their professional services and may also want to show their achievements and recognition in their social circle, friends, family, future employer, future customers etc.

To obtain feedback from customers, many companies spend a lot of time and money to entice their customers to visit the company website or another web link after a purchase and provide feedback about their experience therein. Some service providers, such as those working in retail stores, shops, etc., put efforts of marking printed feedback segment at the bottom of the receipts/bills/invoices and sometimes even add their names and request the customer to give feedback using companies' websites. Sometimes, customer feedbacks are also obtained via telephone calls.

The reality is that not many customers spend the extra time to provide their feedback, as it is a relatively tedious and long process to go through. Additionally, the fact that it is the business that is providing the platform to the customers to give their feedback demands from the customers a high level of loyalty to the business or an obligation towards the business requesting said feedback, that usually does not exist. Providing feedback to a business rather than a person lacks the notion of compassion and/or gratitude that a person-to-person interaction offers. As opposed to a person-to-business interaction, the person-to-person interaction, relying on a bond and a social interaction between two persons, merits a greater probability of genuine feedback by the customers to the service staff member who is actually providing their service to the customer.

Sometimes, customers use online platforms such as 3^{rd} party websites for rating a business such as a hotel, a restaurant, etc., but, such feedback does not directly provide gratitude or additional feedback to the individual person who provided the service.

There have been many research studies in the field of Psychology that strongly link ‘Happiness’ and ‘Gratitude’ together. People are happier when they have something to be thankful for and when they thank someone else. People are also happier when their good work is acknowledged and thanked for.

In view of the above, the present invention is aimed to provide a novel method and system for instantly sending and receiving customer feedback from the customer to the individual service provider with respect to their service. There is also a need to provide management and analysis of the received feedback for future evaluation of service providers at both individual level and at company level. Data collected from individual feedback transactions between two persons, customer and service provider, and aggregated, can provide information about service levels of groups of service providers working at certain company locations, when processed by the system, and may ultimately provide a very clear picture of the aggregated level of service of such company, as a whole, and within a region, or even a specific branch. Such information may be then used by customers as a search and recommendation engine for businesses, ranked by their level of service, without requiring a single customer review to be written.

### SUMMARY

This section is provided to introduce certain aspects of the present invention in a simplified form that are further described below in the detailed description. This summary is not intended to identify the key features or the scope of the claimed subject matter.

In view of the afore-mentioned drawbacks and limitations of the prior art, it is an object of the present invention to provide a system and method providing management of customer gratitude feedbacks received with respect to customer service being rendered to customers by individual service providers in real-time. It is also the object of the present invention to provide a system and method aggregating the individual gratitude feedbacks anonymously, to calculate a service level score of the service provider as well as the branches and locations of an organization, for the benefit of the customers.

Embodiments of the present invention disclose a system for providing management of customer gratitude received with respect to customer service. The system includes a plurality of user devices and a gratitude feedback management application. The plurality of user devices, each of the plurality of user devices is being executed, via a server. The gratitude feedback management application having a graphical user interface configured to: display predefined categories of the customer feedbacks, each category is predefined based on one aspect of the customer service rendered by a first user to a second user; prompt the second user to select at least one predefined category of the customer gratitude feedbacks; receive one or more customer gratitude feedbacks selected under at least one category; analyze the received customer gratitude feedbacks for determining a count of the customer gratitude feedbacks received over time, with respect to each category; assign various award badges to the first user based on the count of the customer gratitude feedbacks received for a particular category cumulatively and for specific periods of time (e.g., day, week, month, year).

In one example embodiment, the first user and the second user are registered with the gratitude feedback management application by creating respective user profiles.

In one example embodiment, the gratitude feedback management module is further configured to authorize the registered users for sending and receiving the one or more customer gratitude feedbacks.

In one example embodiment, the at least one award badge is stored in the memory of the user device.

In one example embodiment, the at least one award badge is displayed via the user interface, while accessing the respective user profiles, both in online and offline mode.

In one example embodiment, the one or more customers gratitude feedbacks include, but are not limited to, text messages, images, slogans, stickers, emojis, and graphic interchanging format (GIF) messages.

In one example embodiment, the gratitude feedback management application is linked to one or more social networks of the first user and the second user.

In one example embodiment, the graphical user interface is further configured to receive at least one personal message from the first user to the second user, and vice versa.

In one example embodiment, the system further comprises an aggregating module configured to: aggregate a plurality of customer gratitude feedbacks in total and per service category, sent by a plurality of second users to a plurality of first users, each of the plurality of first users providing service within same place of business; calculating service scores, total and per service category, for the same place of business, by counting the aggregated customer gratitude feedbacks and statistically factoring the score based on various parameters, including but not limited to industry, geography, time periods, etc.

In one example embodiment, the system further comprises a search and recommendation engine configured to facilitate the second users to search and view the service scores of a particular business place.

Further embodiments of the present invention disclose a method for providing management of customer gratitude feedbacks received in respect of a customer service. The method comprises the steps of: configuring a gratitude feedback management application to be executed on each of a plurality of user devices, via a server, the gratitude feedback management application having a graphical user interface configured for: displaying predefined categories of the customer gratitude feedbacks, each category is predefined based on one aspect of the customer service rendered by a first user to a second user; prompting the second user to select at least one predefined category of the customer gratitude feedbacks; receiving one or more customer gratitude feedbacks selected under at least one category; analyzing the received customer gratitude feedbacks for determining a count of the customer gratitude feedbacks received over time, with respect to each category; assigning award badges to the first user based on the count of the customer gratitude feedbacks received for a particular category; and assigning award badges to the second user based on the count of the customer gratitude feedbacks given for a particular category.

In one example embodiment of the method, the first user and the second user are registered with the gratitude feedback management application by creating respective user profiles.

In one example embodiment of the method, the gratitude feedback management module is further configured to authorize the registered users for sending and receiving the one or more customer gratitude feedbacks.

In one example embodiment of the method, the at least one award badge is stored in the memory of the user device.

In one example embodiment of the method, the at least one award badge is displayed via the user interface, while accessing the respective user profiles, both in online and offline mode.

In one example embodiment of the method, wherein the one or more customers gratitude feedbacks include, but are not limited to, text messages, images, slogans, stickers, emojis, and graphic interchanging format (GIF) messages.

In one example embodiment of the method, wherein the gratitude feedback management application is linked to one or more social networks of the first user and the second user.

In one example embodiment of the method, the graphical user interface is further configured to receive at least one personal message from the first user to the second user, and vice versa.

According to various embodiments of the present invention, the first user and the second user are registered with the gratitude feedback management application by creating respective user profiles. The gratitude feedback management application may be linked to one or more social networks of the first user and the second user. Further, the gratitude feedback management module analyzes the at least one personal message being sent by the at least one user, via the corresponding device, to identify the personal message as one containing profanity. Thereafter, the identified message not containing profanity is allowed to be delivered to the at least one user device. On the other hand, all the messages identified as containing profanity being sent by any user, are blocked or filtered out and are not sent to the at least one user device.

Further, the at least one award badge is stored in the memory of the user device and displayed, via graphical user interface of the gratitude feedback management application, while accessing the respective user profiles, in both online mode and offline mode. The graphical user interface is further configured to receive the at least one personal message from the at least one user, the personal message being a message not containing profanity.

In one example embodiment, the method further comprises aggregating a plurality of customer gratitude feedbacks, in total and per service category, sent by a plurality of second users to a plurality of first users, each of the plurality of first users providing service within same place of business; calculating service scores, total and per service category, for the same place of business, by counting the aggregated customer gratitude feedbacks and statistically factoring the score based on various parameters, including but not limited to industry, geography, time periods, etc.

In one example embodiment, the system further comprises a search and recommendation engine configured to facilitate the second users to search and view the service scores of a particular business place.

This together with the other aspects of the present invention, along with the various features of novelty that characterize the present invention, is pointed out with particularity in the claims annexed hereto and forms a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings' exemplary embodiments. However, the presently disclosed subject matter is not limited to the specific methods and instrumentalities disclosed.

FIG. 1A is the block diagram illustrating the system for providing management of customer gratitude feedbacks, according to an embodiment of the present invention;

FIG. 1B is the block diagram illustrating the various modules of the feedback management application in communication with a database, according to an embodiment of the present invention.

FIG. 1C illustrates an exemplary environment where various embodiments of the present disclosure may function;

FIG. 2A is a screenshot of an exemplary interface showing login and sign up options for accessing a gratitude feedback management system, in accordance with an embodiment of the present disclosure;

FIGS. 2B-2C is a screenshot of an exemplary interface for signing into the gratitude feedback management system via email, in accordance with an embodiment of the present disclosure;

FIG. 2D is a screenshot of an exemplary interface for entering the Great Job screen via a quick response code (QR code) in accordance with an embodiment of the present disclosure;

FIG. 2E is a screenshot of an exemplary interface/screen of scan or select based on geo-location, in accordance with an embodiment of the present disclosure;

FIG. 2F is a screenshot of an exemplary interface/screen of a provider ID (i.e., a first user ID) on the gratitude feedback management system, in accordance with an embodiment of the present disclosure;

FIG. 2G is a screenshot of an exemplary interface of a second user (i.e., a customer) scanning screen while scanning the provider's ID screen of FIG. 2F;

FIG. 2H is a screenshot of an exemplary service provider member (first user) profile search screen showing a list of provider members (i.e., the first users) from which the second user can choose for providing feedback, in accordance with an embodiment of the present disclosure;

FIG. 2I is a screenshot of an exemplary Great Job gratitude feedback giving screen for one selected first user or provider member, in accordance with an embodiment of the present disclosure; The Great Job logo (the drawing of the hand symbolling a “Great Job” award) is then pressed, as an indication to the gratitude feedback management system that the second user wishes to give a Great Job gratitude feedback to the selected first user. The details shown are of the first user, so that the second user may verify that the person that provided the service is indeed the first user seen on the screen.

FIG. 2J is a screenshot of an exemplary additional, optional, more detailed category Great Job gratitude feedbacks giving screen where the second user (i.e., the customer) can click on none, or any combination of the additional GJ gratitude feedbacks, in accordance with an embodiment of the present disclosure;

FIG. 2K is a screenshot of the exemplary additional category Great Job (GJ) gratitude feedbacks giving screen where the second user can click done tab or can leave a personal comment, in accordance with an embodiment of the present disclosure;

FIG. 2L is a screenshot of the exemplary additional category Great Job (GJ) gratitude feedbacks giving screen when the second user tries to close without selecting done or leave a message tab, in accordance with an embodiment of the present disclosure;

FIGS. 2M-2O illustrates screenshots of the exemplary second user's personal note screen, where the second user can leave a message for the provider (i.e., the first user);

FIG. 2P is a screenshot of the exemplary daily activity summary screen of a provider, (e.g., the first user), in accordance with an embodiment of the present disclosure;

FIG. 2Q is a screenshot of the exemplary activity screen of a provider member, (e.g., the first user) illustrating additional activity attributes, whereby in this example the provider member is also a customer, in accordance with an embodiment of the present disclosure;

FIG. 2R is a screenshot of an exemplary daily detailed activity screen of a provider, as an example, for the general type Great Job gratitude feedbacks given to the provider by customers throughout a specific calendar day, in accordance with an embodiment of the present disclosure;

FIG. 2S is a screenshot of an exemplary daily activity summary over one calendar week screen of a provider, as an example, for the general type Great Job gratitude feedbacks given to the provider by customers throughout each day of a specific calendar week, in accordance with an embodiment of the present disclosure;

FIG. 2T is a screenshot of an exemplary daily activity summary over one calendar month screen of a provider, as an example, for the general type Great Job gratitude feedbacks given to the provider by customers throughout each day of a specific calendar month, in accordance with an embodiment of the present disclosure;

FIG. 2U is a screenshot of an exemplary monthly activity summary over one calendar year screen of a provider, as an example, for the general type Great Job gratitude feedbacks given to the provider by customers throughout each month of a specific calendar year, in accordance with an embodiment of the present disclosure;

FIG. 2V-2W is a screenshot of an exemplary social screen listing social networks friends of a user, (e.g., the first user, second user), whereby the friends have either been thanked for their service as provider members or have thanked other provider members as customers, in accordance with an embodiment of the present disclosure;

FIG. 2X is a screenshot of an exemplary social screen listing all Great Job type gratitude feedbacks and messages that the first, provider member, user has received from any and all other, customer, users, as well as award badges received from the gratitude management system.

FIG. 2Y is a screenshot of an exemplary social screen showing a message delete confirmation, after the first user wishes to delete a message sent to him by a second user, in accordance with an embodiment of the present disclosure;

FIG. 2Z is a screenshot of an exemplary social screen after a message has been deleted by the first user, in accordance with an embodiment of the present disclosure;

FIG. 3A is a screenshot of an exemplary award badges screen, in accordance with an embodiment of the present disclosure;

FIG. 3B is a screenshot of an exemplary full screen view of an award badge, in accordance with an embodiment of the present disclosure;

FIG. 4A is a screenshot of an exemplary main profile screen for a user such as a provider member and/or a customer member profile, in accordance with an embodiment of the present disclosure;

FIG. 4B is a screenshot of an exemplary edit profile screen for a user, in accordance with an embodiment of the present disclosure;

FIG. 4C is a screenshot of an exemplary new profile screen for a user for registering with the gratitude feedback management system, in accordance with an embodiment of the present disclosure;

FIG. 4D is a screenshot of an exemplary profile screen of the user for connecting to one or more of their social networks, in accordance with an embodiment of the present disclosure;

FIG. 4E is a screenshot of an exemplary workplaces screen showing a number of workplaces, past and present, entered by the user, in accordance with an embodiment of the present disclosure;

FIG. 4F is a screenshot of an exemplary workplace view screen showing details of a workplace on a selection by a user, in accordance with an embodiment of the present disclosure;

FIG. 4G is a screenshot of an exemplary workplace options screen for a specific workplace where the user can edit or delete the workplace, in accordance with an embodiment of the present disclosure;

FIG. 4H is a screenshot of an exemplary workplace delete warning screen for a specific workplace to confirm deletion of the workplace;

FIG. 4I is a screenshot of an exemplary workplace edit screen for editing a specific workplace;

FIG. 4J is a screenshot of an exemplary workplace edit cancel warning screen to confirm cancellation of editing of a specific workplace before any changes were saved;

FIG. 4K is a screenshot of an exemplary workplace add screen for adding a new workplace;

FIG. 4L is a screenshot of an exemplary workplace add cancellation screen for canceling adding of a new workplace before any changes were saved;

FIG. 5A is a screenshot of an exemplary provider member badge screen, presenting, the user's badge, so that, for example, the customer member would be able to scan the provider member's QR code and give them a GJ gratitude feedback for great customer service rendered;

FIG. 5B is a screenshot of an exemplary print/share badge screen for selecting a style of badge when the user wishes to print a badge on, for example, sticker paper, or send the badge image to a 3rd party vendor which makes custom plastic or metal badges;

FIG. 5C is a screenshot of an exemplary print/share badge choose statement screen for enabling the user to select a sticker statement for the badge;

FIG. 5D is a screenshot of an exemplary print/share badge preview screen for enabling the user to preview the badge with a statement prior to printing;

FIG. 5E is a screenshot of an exemplary print/share badge statement screen for enabling the user to enter a custom statement for the badge;

FIG. 5F is a screenshot of an exemplary print/share badge preview screen for enabling the user to preview the badge with a custom statement prior to printing;

FIG. 5G is a screenshot of an exemplary certificate of excellence in customer service screen of the provider member user;

FIG. 6A is a screenshot of an additional exemplary social network screen of the user like a customer or a provider member;

FIG. 6B is a screenshot of an additional exemplary social network screen when a specific social network is selected;

FIG. 7 is a screenshot of an additional exemplary activity screen where the user can view their daily activity, both as a provider and as a customer; and

FIG. 8 is a screenshot of an additional exemplary award badges screen where the user can view all the badges collected by him/her.

Like reference numerals refer to like parts throughout the description of several views of the drawings.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Reference throughout this specification to “a select embodiment”, “one embodiment” or “an embodiment” means that a particular feature, structure, or characteristic described in connection with the embodiment is included in at least one embodiment of the disclosed subject matter. Thus, appearances of the phrases “a select embodiment” “in one embodiment” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

As used in this specification and the appended claims, a module refers to a device, system or a hardware configured to perform one or more functions or instructions according to the method disclosed in the present disclosure. The module can be a single device or multiple devices configured to perform one or more functions or instructions according to the method disclosed in the present disclosure.

The embodiments used herein are for organizational purposes only and are not meant to be used to limit the scope of the description or the claims. As used throughout this application, the word “may” is used in a permissive sense (i.e., meaning having the potential to), rather than the mandatory sense (i.e., meaning must).

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

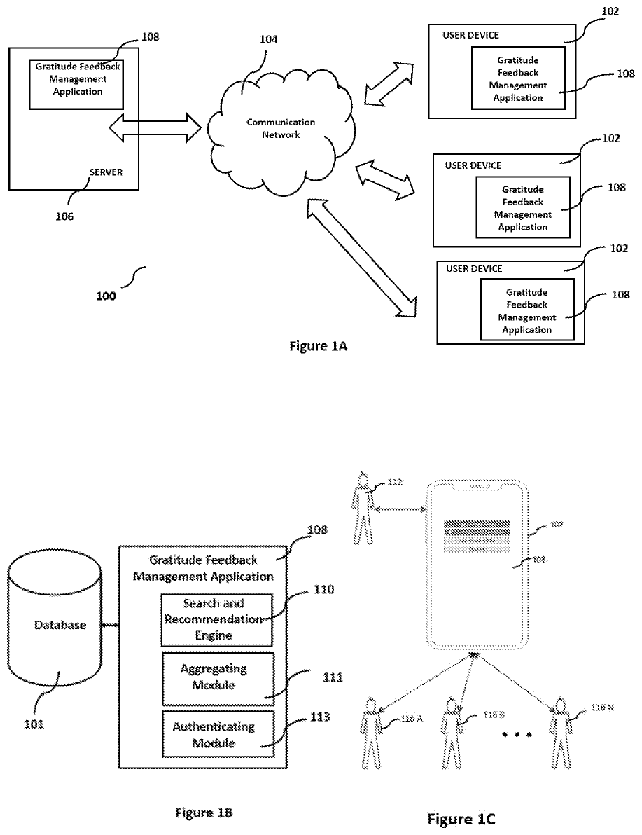

FIG. 1A is the block diagram illustrating the system 100 for providing management of customer gratitude feedbacks, according to an embodiment of the present invention. The system 100 comprises a plurality of user devices 102. Each of the plurality of user devices 102 is communicably connected to a server 106 in a network 104 for executing a gratitude feedback management application 108. The gratitude feedback management application 108 comprises a graphical user interface or interface configured for displaying predefined categories of the customer gratitude feedbacks. The categories are predefined and stored in a database 101 (shown in FIG. 1B) or memories or any storage devices which may be accessed by the gratitude feedback management application 108. The categories are predefined based on specific aspects of the customer service rendered by a first user to a second user. The first user and the second user are registered with the gratitude feedback management application 108 by creating respective user profiles. The first user and the second user are using at least one of the plurality of user devices 102. Further, the gratitude feedback management application 108 is configured for prompting the second user to select at least one predefined category of the customer gratitude feedbacks. The customer or the second user, via the respective user device 102, selects a category and sends the gratitude feedbacks under at least one selected category. The first users may receive multiple gratitude feedbacks on his/her user device 102 from various customers or the second users. The gratitude feedback management application 108 is further configured to analyze the received customer gratitude feedbacks for determining a count of the customer gratitude feedbacks received over time, with respect to each category. One or more awards, such as a badge or a sticker, may be awarded or assigned to the first user based on the count of the customer gratitude feedbacks received for a particular category. One or more awards, such as a badge or a sticker, may be awarded or assigned to the second user based on the count of the customer gratitude feedbacks given for a particular category.

In one embodiment of the present invention, the one or more customers gratitude feedbacks include, but are not limited to, text messages, images, slogans, stickers, emojis, and graphic interchanging format (GIF) messages. Further, the graphical user interface is configured to receive at least one gratitude message from the first user to the second user.

In one embodiment of the present invention, a ‘Gratitude Icon’ or ‘gratitude icon’ is displayed on the user interface. A library of gratitude icons is stored in the database 101 and the second users (i.e., the customers) are thereby facilitated to select an icon from the library and thereafter send the selected gratitude icon to the first user device 102. The gratitude icon is provided to facilitate the users to send the icons in addition to the text messages or customer gratitude feedbacks. The library of icons includes a plurality of animated GIF, emojis, stickers, images, etc. The received icons are also shown in the Me and Friends Feeds.

FIG. 1B is the block diagram of the gratitude feedback management application 108 having various modules therein. The gratitude feedback management application 108 comprises an aggregating module 111 and an authenticating module 113. The gratitude feedback management application 108 is in communication with the database 101 within the communication network 104. The database 101 is accessed by the gratitude feedback management application 108 to send and receive a plurality of data pertaining to management of customer gratitude feedbacks.

The aggregating module 111 comprises a counter that counts the number of customer gratitude feedbacks being sent/received in one or more categories. The one or more categories is predefined based on at least one aspect of service rendered by the first user to the second user. The predefined categories are stored in the database 101 and can be accessed by the gratitude feedback management application 108. The predefined categories include various predefined aspects of the service performed by the first user while rendering their services to the second users. For example, in one embodiment of the present invention, the categories may include a general ‘Great Job’ category, for overall service gratitude feedback, as well as ‘Friendly’, ‘Prompt’, etc., to refer to different aspects of the service performed by the first user. The aggregating module 111 is also configured to analyze the received customer gratitude feedbacks for determining the count of the customer gratitude feedbacks received over time. The first user is assigned award badges based on the count of the customer gratitude feedbacks received/given for each particular category. The assigned award badges and the gratitude feedbacks received/given under various categories are accumulated or aggregated with respect to each user. In one embodiment of the present invention, the award badges are stored for each user, in the memory of the user device 102 and on the server. Further, the award badges may be displayed via the user interface, while accessing the respective user profiles, both in online and offline mode. This facilitates the user to showcase the award badges and gratitude feedbacks received/given count under a particular category in the future. In one embodiment of the present invention, the user interface displays award badges with respect to a particular job or business place. This provides options to the second users to see the award badges of the first user per business place or per job/company.

The further aggregated data pertaining to service excellence of multiple first users working at the same certain company branch, brands, etc., may ultimately provide a very clear picture of the aggregated level of service of such company, as a whole, and within a region, or even a specific branch. Such information may be then used, shown, and recommended by a search and recommendation engine 110.

In one embodiment of the present invention, the gratitude feedback management application 108 is linked to one or more social networks of the first user and the second user to facilitate the users to showcase their respective profiles with received award badges within their social circle. In one embodiment of the present invention, the first user is facilitated to allow various professional recruiters to view his/her profile and achievements on the gratitude feedback management application or via various networking sites or platforms for showcasing his/her user profile with aggregated award badges and positive or gratitude feedbacks. Thus, the management and analysis of the received customer feedbacks by the gratitude feedback management application 108, not only motivates the first user in real time, but also helps in future evaluation of service excellence at both individual level and at company level.

In one embodiment of the present invention, the gratitude feedback management application 108 implements a geofencing module which determines the location of the user devices 102. When the second user enters and then exits the business location of the first user after a preconfigured amount of time, the geofencing module sends a notification on the associated user device 102 of the second user to prompt the second user to give the customer gratitude feedbacks to the first user.

In one embodiment, the aggregating module 111 is configured to aggregate a plurality of customer gratitude feedbacks sent by a plurality of second users to a plurality of first users wherein each of the plurality of first users provides service within the same place of business, such as, same branch of any organization, airport, hotel, restaurant, bank, etc. The aggregating module 111 further calculates service scores (i.e., a general score and one for each of the service categories) for the same place of business, by counting the aggregated customer gratitude feedbacks and factoring in various configurable parameters, such as geography, period of time, industry, etc. These service scores may be used by the search and recommendation engine 110 configured to facilitate the second users to search and view the recommendation of a particular business place and refer to the service scores of that particular business place.

In one embodiment of the present invention, the gratitude feedback management application 108 is configured to provide a ‘manager shout-out’ feature which may be used by the second user to let the manager or employer of the first user know of the second user's gratitude for and appreciation of the first user's high level of service.

In one embodiment of the present invention, the gratitude feedback management application 108 is further configured to facilitate the first users to post their selfie or a picture with the customers or the second users, and vice-versa. The first user may also post a textual or graphical or any other posts in their feed which may have a feature to enable the second users to subscribe or follow the first user and vice-versa.

The authenticating module 113 is configured to facilitate the first user and the second user to get registered with the gratitude feedback management application 108 by creating respective user profiles having display photograph of the user or another image picked by the user. The authenticating module 113 ensures that the feedbacks are sent from authentic users. The users may sign in to the gratitude feedback management application 108 using valid credentials such as User ID and a password, in accordance with an embodiment of the present disclosure. The authenticating module 113 may also check validity of the credentials and authenticate the user accordingly. This facilitates the gratitude feedback management application 108 to authorize the registered users for sending and receiving the one or more customer feedbacks. In one embodiment of the present invention, a feature of flipping the image/photograph of the user may be provided to look at the user profile information of the authentic users.

FIG. 1C illustrates an exemplary environment where various embodiments of the present disclosure may function. The environment primarily includes the plurality of user devices 102 (also termed as an electronic device or a computing device), each device executing a gratitude feedback management application and capable of sending and receiving gratitude feedback messages and personal messages. A first user 112 may be associated with respective user device 102. The associated user device 102 may be communicatively coupled with one or more of the plurality of user devices 102 and connected to the server 106 via the network 104. The second user 116, within a communication network. In one embodiment of the present invention, there may be a plurality of customers, (i.e., the second user) 116A-116N. The first user 112 may use the respective associated user device 102 for accessing the gratitude feedback management application 108. The first user 112 may be a person or an individual working in a customer facing role at a company, for example an employee in a café, hotel, restaurant, etc. The gratitude feedback management application 108 facilitates the first user 112 to receive and manage customer gratitude feedbacks sent by the second users 116A-116N in response to the service being received. The first user 112 may register or sign up with the gratitude feedback management application 108. For example, the first user 112 may sign up or set up a profile and log in to the gratitude feedback management application 108 via a social network log in details, an email, or by providing other details, etc.

The first user 112 (hereinafter may also be referred to as a service provider member, or simply ‘provider member’) may be any user providing a service to the second users 116A-116N. Examples may include a waiter in a restaurant, a store associate or cashier, an airline check-in counter person, a flight attendant; the front-desk associates at the hotels, an online customer facing chat representative, a telephone customer facing representative, etc. The provider member may be an active participant in this service.

In some embodiments of the present invention, the first user 112 may be a customer facing employee of a company or group. Examples of the companies such as, but not limited to, Best Buy, Staples, Hilton, McDonalds, Macy's, Starbucks, etc. Companies may have a profile on the system and would be mapped to geographies, regions, branches, etc. The Company may have sub entities to best map the organization. This can be branches, individual restaurants, regions, etc. Each branch must have a unique identifier and an address, and the provider members would be mapped in the system to their individual branches by some sort of an identifier. Therefore, a provider member ends up being tied to both the Company (the brand, the company. e.g., Staples) AND to a Group within the Company (e.g., Burlington, Mass., Branch #, Airport for an airline, etc.). thus, the gratitude feedback management application maintains a directory or database 101 of a plurality of companies, employers, the addresses and locations of the companies, etc.

The profile of the Groups may include a list of Group Identifiers, Achievements: <awards and Badges, etc.> etc. Groups which are part of the Company. The Group is a branch, a specific store, a specific airport, a restaurant, etc., and more importantly, an entity that groups several Providers together. For example, the Staples store in Burlington, MA, is a Group. This is important because Groups can achieve merits of excellent service, based on the individual achievements of their provider members, in the current time and even over a period of time. Groups can flaunt their achievements in the form of a physical signs and stickers that are hung or placed on the front door, just like the TripAdvisor and Yelp “People like us on ” signs. These will be specific signs and stickers of the gratitude feedback management application, which will address the level of service of that store, branch or restaurant and will mean to the visitor—you are welcome here. High ratings of the groups may indicate high level of service, expertise, etc. The group profile may include one or more information comprising: system ID: <number>, Company ID: <number> of the Company this Group belongs to, Group Name, Group Number within the Company: <number as in Store number, etc.>, Address, e-mail address, Lead Provider: <ID of head of the Group. (e.g., Store Manager), etc.>, Achievements: <Group badges, etc.>, etc.

Company and Group can each have a social network profile with their Facebook, Twitter, etc., profile identifiers. This allows the gratitude feedback management application 108 to send to the Company or the Group an e-mail or make available a link on the gratitude feedback management application 108 for a special Group or Company badge that they can publish to their Social Networks (including Facebook page, Twitter account, Instagram, Pinterest, etc.) or on their Yelp or TripAdvisor profile pages.

It is crucial to audit and guard the authenticity of any achievement and publication originating from the gratitude feedback management application 108, if it is to become a valid indicator of excellence in customer service.

The second users 116A-116N may be any user or customers who receive the services rendered by the provider member or the first user 112. In some instances, the first users (provider members) may also become the second users (customers) when they receive services from other provider members, and vice versa. Thus, the present invention facilitates a user to both send and receive customer gratitude feedbacks, via the respective user device.

As used herein, the company may include companies that employ the first user or the provider members. They don't take an active role in the service/community. They are an observer on an anonymous basis. Eventually, when enough data is collected, they can use the gratitude feedback management application 108 to get aggregated, anonymous reports pertaining to their service level, at granular levels of service (friendliness, proficiency, promptness, overall level of service), divided by different general parameters.

Further, as used herein, a Group may be a unit within the company. One store in a chain, one restaurant, one branch of a business, etc. The group is important because it can display group achievement, once reached. For example, a Staples store can achieve a certain merit, which is a collection of its individual provider members' merits and get a special sticker to stick on the main door, just like businesses are doing with Yelp stickers and TripAdvisor stickers. People may want to come to stores with very high service level displayed by their employees.

According to an embodiment of the present invention, the gratitude feedback management application 108 is configured to allow the second users to send only gratitude feedback to the first user 112, via respective user devices 102. The first user 112 may access the gratitude feedback management application 108 on the first user device 102 and open an identifier screen displaying a provider member badge, where the second user 116A-116N can identify the provider member as the one that provided them the good service and provide gratitude feedback like a Great Job gratitude feedback. A general Great Job gratitude feedback and optional additional, more detailed gratitude feedbacks, for prompt (i.e., efficient) service, professional (i.e., knowledgeable) service and friendly service granted. An award, such as a badge or a sticker may be awarded or assigned to the first user based on the count of the customer gratitude feedbacks received for a particular category. Further, the second user may also send to the first user a personal message which are essentially gratitude messages.

In some embodiments, the second users 116A-116N may also have an associated second device for accessing the gratitude feedback management application 108. The second users 116A-116N have to register or sign up with the gratitude feedback management application 108. For example, each of the second users 116A-116N may sign up or set up a profile using their social network log in information, or their email, and then providing other details, etc. In such scenario, when the second users 116A-116N enjoys a service provided by the first user 112, they can provide gratitude feedback by accessing the gratitude feedback management application 108 on their associated second computing device. The second users 116A-116N may find the first user's profile on the gratitude feedback management application 108 by scanning a quick response (QR) code displayed to them by the first user 112, or by searching for them on the gratitude feedback management application 108 and selecting the first user and this will open up first user's 112 profile on the second computing device 102. The second users 116A-116N thereafter gives a gratitude feedback about the first user 112 via their second computing device 102.

In some embodiments, the second users 116A-116N may serve other users, for example providing one or more services to clients in an office, whereby the second users 116A-116N may receive gratitude feedback from other users via the gratitude feedback management application 108.

Examples of the user's device 102 may include, such as, but not limited to, a computer, a laptop, a tablet computer, a smart watch, a smart phone, a smart television, and so forth. Each user device has a processor or processing unit for operating/executing the gratitude feedback management application 108.

The gratitude feedback management application 108 may be a web and mobile based social network to enable customer facing employees at retailers, restaurant chains, airlines and practically anyone that provides direct service to the customer, to collect gratitude feedback from the customer about their good service, build aggregated gratitude feedback over time and present it on a website as well as on other social media platforms like LinkedIn, Facebook, Twitter, Pinterest (e.g., award badges), Instagram (e.g., award badges), etc. The key point about this gratitude feedback management application 108 is that it is only a gratitude feedback platform from one individual customer (the second users 116A-116N) to one individual service provider (i.e., the first user 112), as opposed to a “five star” rating system that is often used to rate businesses, products and even individuals.

The gratitude feedback management application 108 lets the customers thank provider members/first users 112 for their good service. Customers can also be provider members and vice-versa and the gratitude feedback management application 108 may enable the user to decide what action they wish to perform at any given time (i.e., provide gratitude feedback/thanks or get gratitude feedback/thanks). The customer may have a few attributes, which are unique to him/her, such as the customer badges, etc. All history will also be saved in the database 101 of the gratitude feedback management application 108.

The first user 112 may also decide what to share on their social networks—every event, daily digest, weekly digest, monthly digest, new badges, etc.

In some embodiments, the gratitude feedback management application 108 may be present in a device like a server 106 in a network 104 including communication network and a cloud network. The gratitude feedback management application 108 may be executed on a single device or multiple devices. Further, the gratitude feedback management application 108 may be a web-based system that can be accessed via a web link like a uniform resource locator or may be implemented as an application on a computing device.

The gratitude feedback management application 108 may be a social network for people commending other people's customer service level. The second users 116A-116N may be consumers who enjoy good service from the first user or the provider member. The second users 116A-116N may provide gratitude for the service received from the first user 112 in several categories, such as, friendliness, proficiency (i.e., knowledge), promptness (i.e., efficiency) and overall level of service provided. More service attributes can be added but it is very important to keep the process of giving gratitude very simple, to the level that the gratitude feedback giver, the customer, can give their gratitude feedback right there, on the spot, at the store/service location and not meddle with too much information to key in. The gratitude feedback management application 108 may enable the second users 116A-116N to give gratitude feedback in various categories to the first user via short and simple sequence of clicks.

In some embodiments, feedback can only be good (i.e., gratitude). The gratitude feedback management application 108 may be a platform or service that the first user (i.e., the provider members) want to belong to, be proud of and grow as individuals and as groups, whether within the same company or throughout their career. There is only a “Star” (or the likes of it) given for good service and never bad rating for bad service. There is never a bad review.

The gratitude feedback management application 108 draws its attractiveness from people's (in this case, the second users 116A-116N) psychological desire and tendency nowadays to rate everything. This may include products, stores, sellers, restaurants, hotels, businesses, plumbers, electricians, etc. in their day-to-day life.

Further, the gratitude feedback management application 108 draws its attractiveness from people's (in this case, the first user) tendency nowadays to want to be seen and be noticed, to be famous, to have so many aspects of their life put on display. This is evident by the tremendous participation and self-publishing of people on Facebook, Twitter, Instagram, etc.

The gratitude feedback management application 108 draws its attractiveness also from people's never-ending pursuit of happiness and the strong link that has been established between gratitude and happiness in modern psychology. The gratitude feedback management application 108 provides a platform for both the first user 112 to receive gratitude and acknowledgment for their merits in service as well as the second users 116A-116N to be grateful for good service they receive and pay it forward by thanking the first user 112.

The gratitude feedback management application 108 enables the user like first user 112 to join and take their careers and professional destiny in their own hands, and show how great they are, without being dependent on the company they work for. A key factor of the gratitude feedback management application 108 is that it is by the individuals and all about the individuals and not offered by the corporation that employs the individuals. Groups of workers (or users) can individually join the gratitude feedback management application 108 and put their pride in and affinity with their group to work as they contribute to their group's score and in time, when enough group members or employees of a company collect enough gratitude feedback, this can immediately trickle to becoming a company service level indicative mechanism, branch service level, region service level, company within its vertical, etc. Another factor of the gratitude feedback management application 108 is that this service level indication mechanism of the gratitude feedback management application 108 may create a healthy competition. Competition between employees of the same group (e.g., store, restaurant, branch, etc.) and competition between branches, brands, territories/regions, etc., of the same company. Healthy competition always creates better service and better results. Employers may like the service as it incents their employees to try harder. Customers (e.g., the second users 116A-116N) would like the service because it gives them a fast and convenient way to reward good service.

The gratitude feedback management application 108 enables the first user 112 to keep all the gratitude feedbacks comprising thanks, award badges, certificates, messages, etc. in one place as a profile on the gratitude feedback management application 108. The user can link the profile to their social networking accounts. Further, the user can share their profile with other users via suitable means comprising a link, a URL, and so forth.

Further, the user can check his/her activity of the gratitude feedback management application 108 on daily, monthly, or yearly basis. The gratitude feedback management application 108 may display the activity in form of graphs, charts, numbers, etc. Further, the user can keep a track of all the personal messages or feedbacks received in all the workplaces where the user has worked so far via the profile on the gratitude feedback management application 108.

The gratitude feedback management application 108 is a web and/or mobile based social network for giving gratitude feedback to the user including an individual service provider member (like the first user 112) from individual customers (like the second users 116A-116N). The gratitude feedback must be positive only, like a high star rating (i.e., a “Great Job” gratitude feedback) or “good”, “great” or “awesome” levels of service feedback.

The first user 112, the service provider member, or the second users 116A-116N can build their profile on the gratitude feedback management application 108 and provide basic attributes on their profile and display their scores/merits wherever possible. An example of an important attribute of the first user 112 is the company they work for presently, and in the past. The users can further connect this profile to other social networks like Facebook, LinkedIn, etc. for showing people their achievements and for future networking.

The second users 116A-116N, the customers, may give gratitude for service provided by the first user 112 (may also be referred to as a provider member) in several categories, such as, friendliness, proficiency (i.e., knowledge), promptness (i.e., efficiency) and overall level of service provided. The gratitude feedback management application 108 enables the second users 116A-116N (i.e., the customers) to provide instant gratitude feedback to the first user 112 with the help of identifiers such as a QR code. This code may be available on the profile of the first user 112 and the second users 116A-116N can scan it and give their valuable gratitude feedback right there where and when the service was performed. The gratitude feedback management application 108 may generate a score, for example, on the basis of various parameters, including but not limited to accumulated number of gratitude feedbacks granted to each provider member. With the increase in this score the first users can get award badges and rewards which will help increase the visibility of the users and assist them in getting new and more lucrative jobs. The gratitude feedback management application 108 helps in creating a universal social network for every user like a service provider member or we can say it's a social network for customer facing workers, helping them in getting identified for new jobs.

In an example, the employees (like the first user 112) of the same company branch would want their fellow employees to join the network and promote their branch, by collecting as many gratitude feedbacks they can and adding to the group's score on the network. Pride in their brand and loyalty to their group of friends would stimulate many people to join the service and “pitch-in”. The network can send them a placard to hang on the door when they reach a certain collective score or when they reach a certain rank among others around them.

In some embodiments, the desire of the first user 112 to flaunt their score can be fulfilled by widgets on sister networks such as Facebook and LinkedIn. There can be an award badge on each of these to show off their achievements. The gratitude feedback management application 108 provides a mechanism to publish their achievement on Twitter, Facebook, Instagram, LinkedIn, as a post, etc.

In some embodiments, the provider members (the first user 112) are also customers (116A-116N). For example, when company X's sales associate goes out on his/her break and grabs a cup of coffee at the cafe across the street, she/he transforms from being a provider member at company X to being a Customer at the cafe. When presented by the cafe cashier to give gratitude for his/her excellent service on the gratitude feedback management application 108, the company X's associate is intrigued and asks the café's cashier about the application she/he just downloaded and then creates her/his own profile on the network, to ask her own customers to provide their feedback on her own great service. This is an inherent viral characteristic of the gratitude feedback management application 108.

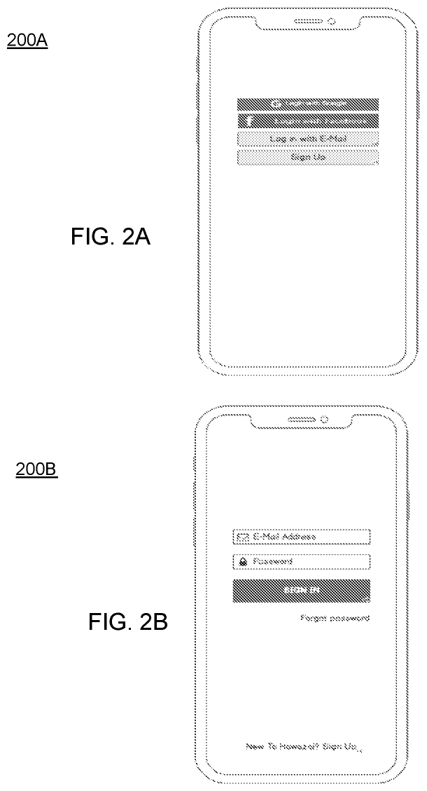

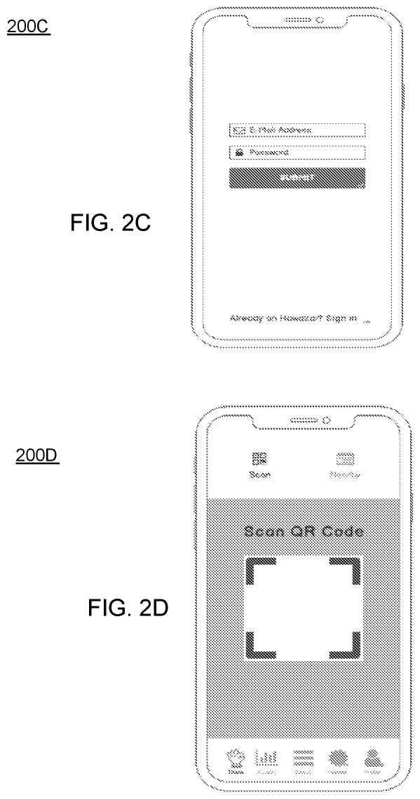

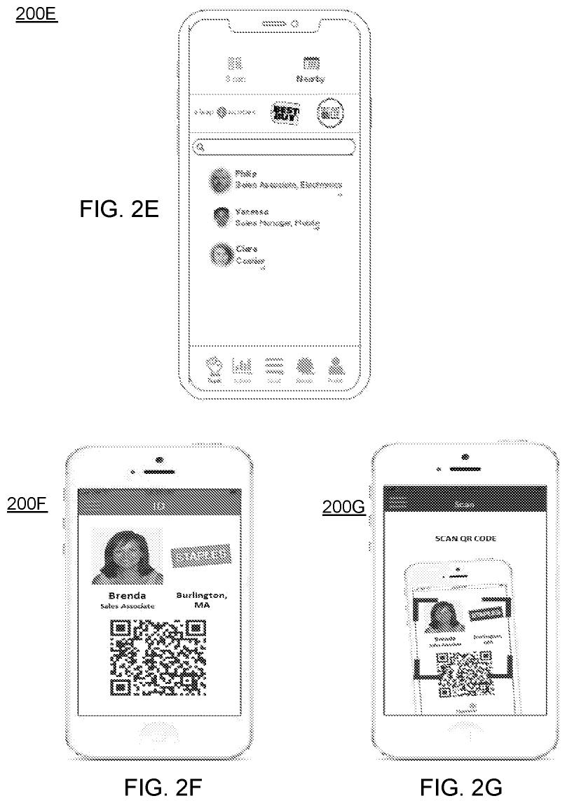

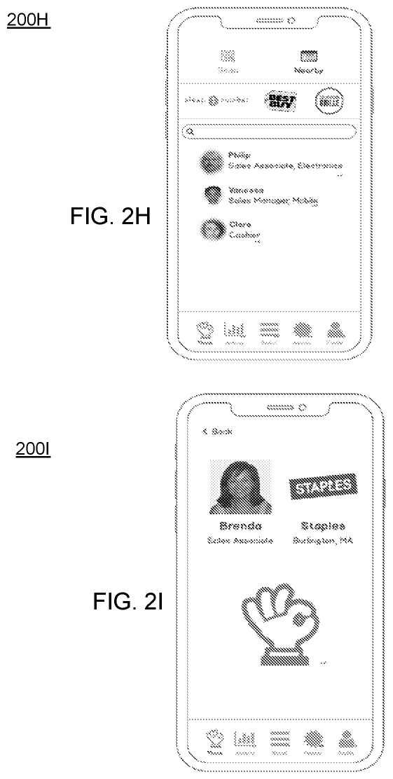

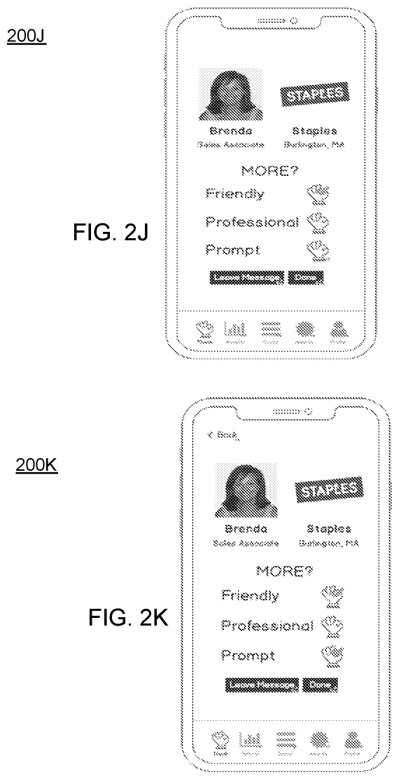

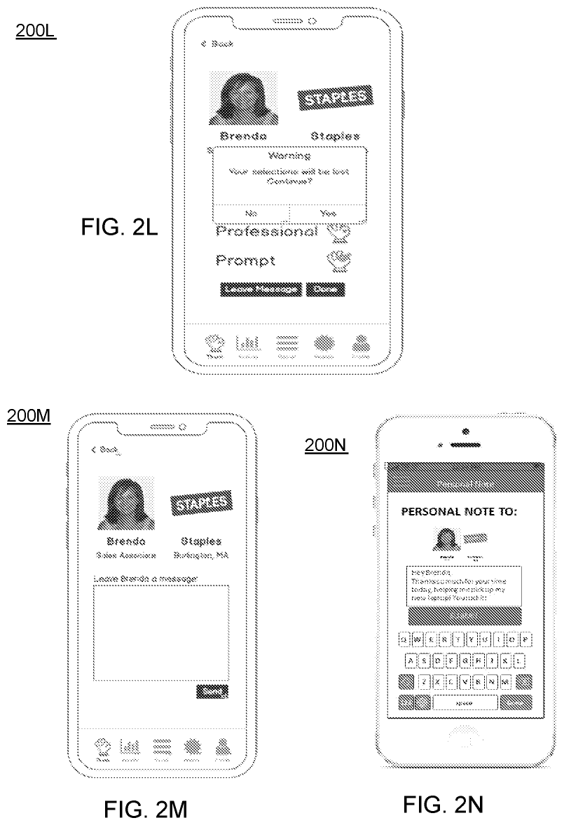

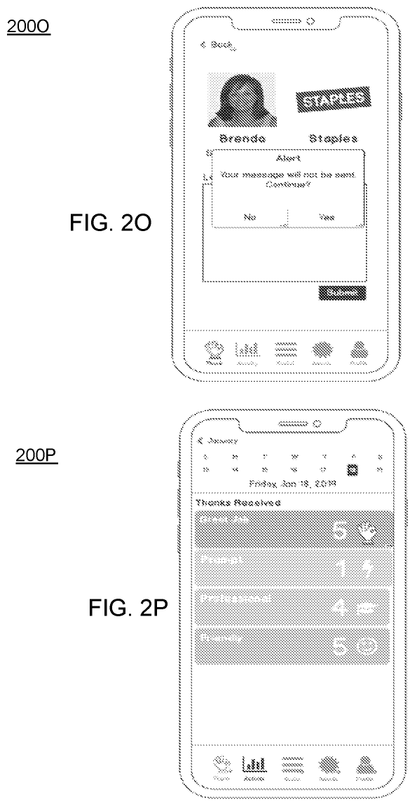

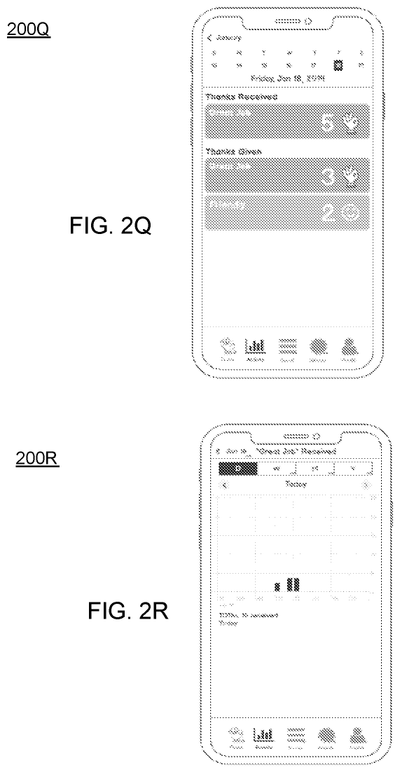

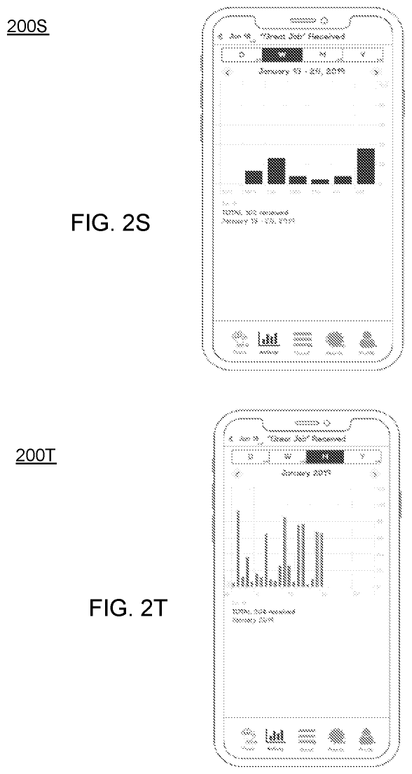

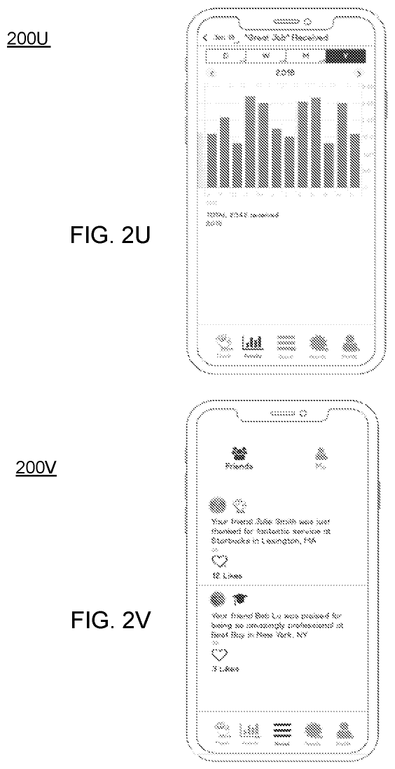

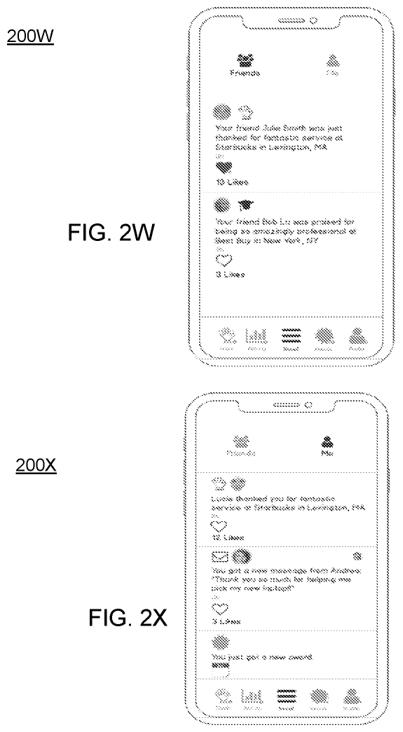

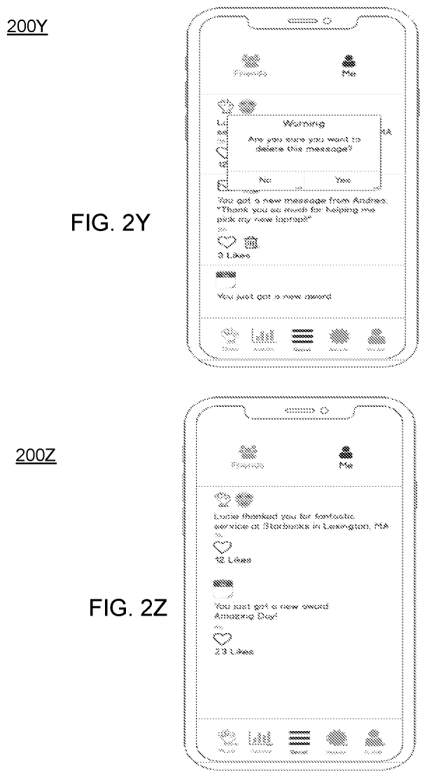

FIG. 2A is a screenshot of an exemplary interface 200A showing login and sign up options for accessing the gratitude feedback management application, in accordance with an embodiment of the present disclosure. The gratitude feedback management application may be the feedback management application 108 of FIG. 1. The user on a computing device like the first user 112 or second users 116A-116N accesses the interface 200A on the first computing device 102. The user can login in different ways like via Google, Facebook, email. New users may create a new profile.

In some embodiments, the Sign-in interface 200A may not always appear in the app. The gratitude feedback management application implemented as a mobile app may auto-sign-in, unless specified that it may not. The sign-in screen will be the same for the Customer and the Provider Member and will allow the users to choose whichever functionality they would like to use at any given time, that of a Provider Member or that of a Customer. The gratitude feedback management application 108 does not distinguish between users of a certain kind as each user can be either or both types.

If this is a new user, the gratitude feedback management application 108 may offer (on the sign-in screen) to register as a new user (sign-up). The gratitude feedback management application 108 can also offer the user to sign-in automatically next time they open the app. This can either be done automatically or a check box can show on the sign-in screen below.

FIG. 2B is a screenshot of an exemplary interface 200B, for signing in to the gratitude feedback management application 108 using the user's email address as their User ID and a password, in accordance with an embodiment of the present disclosure. The existing user can login by entering an email address. The user can choose to login automatically next time until they decide to sign-off. The interface 200B may include a forgot password option and a sign off option to. The password may have password rules etc. The gratitude feedback management application 108 may check validity of the email address etc. and authenticate the user accordingly.

FIG. 2C is a screenshot of an exemplary interface 200C for a new user signing up to the gratitude feedback management application 108 using the user's email address as their User ID and a password in accordance with an embodiment of the present disclosure. The password may have password rules etc. The gratitude feedback management application 108 may check validity for the email address etc. and authenticate the new user accordingly.

The user interfaces of the gratitude feedback management application 108 are simple as possible in order for the user interaction with the application at the place of service to be as quick as possible. The users may sometime delay a line of customers behind her and the whole process of finding the Provider and providing customer feedback, should take just a few seconds.

FIG. 2D is a screenshot of an exemplary interface 200D for use by the customer user 116A-116N to identify the first user 112 in the gratitude feedback management application 108 and entering the Great Job gratitude giving screen for that specific first user 112, using a quick response code (QR code) in accordance with an embodiment of the present disclosure. The interface 200D appears for scanning QR code when the people like the second users 116A-116N want to thank someone or give gratitude feedback about the first user 112. As shown, there may be two options at the top of the interface 200D to locate and identify the first user 112.

FIG. 2E is a screenshot of an exemplary interface/screen 200E of welcome/Push to Scan screen, in accordance with an embodiment of the present disclosure. Once the Customer signed in, the gratitude feedback management application 108 may present the customer with the Push-to-Scan screen 200D. Alternatively, she can already be presented with the Scan screen or she can be presented with one of the other main screens of the application, such as the Activity screen 200P, shown in FIG. 2P. The Customer may either choose any of the application Menu items (to be discussed) or push the Scan button. Alternatively, the customer may first be presented with the provider search screen 200H as shown in FIG. 2H, with a Scan button that can be introduced on this screen.

Once the Customer pushes the Scan button, she is presented with a QR code scanner. The Provider, in turn, will display his ID screen. The purpose of this process is, again, to save precious time in the process. An example of the user or provider member ID screen on shown in FIG. 2F.

FIG. 2F is a screenshot of an exemplary interface/screen 200F of a user (i.e., a first user 112) on the gratitude feedback management application 108, in accordance with an embodiment of the present disclosure. The customer can scan the QR code of the first user 112. The QR code is a unique identifier, which is automatically generated for the provider member/first user 112 and is part of their profile. The purpose of this code is to enable quick identification of the provider member by the customer, so that they can thank the provider member. The customer side of the interface/screen 200F of the gratitude feedback management application 108 may have a QR code reader, which may then show them the (quickly) identified provider member on the network and let them thank them.

FIG. 2G is a screenshot of an exemplary interface 200G of one of the second users 116A-116N (i.e., a customer) scanning screen while scanning the first user's (i.e., the provider member's) ID screen 200F of FIG. 2F. The Customer then scans the Provider's ID Screen with her Scanning screen 200G.

In some embodiments, the provider member (i.e., the first user 112) may not have a smartphone at hand and can print his ID badge from the profile of the gratitude feedback management application 108 at home on a sticker or piece of paper, to be presented to the Customer for scanning. The gratitude feedback management application 108 may let the Provider member/user print his/her ID badge or they can send application 108 a request with only shipping and handling fees (to be determined) and they will get a sticker or a laminated card with their ID to the user's selected address.

As soon as the QR code is scanned, the customer is presented with the details of the provider member, for them to make sure that they are indeed thanking the right person, and on that same screen is a big “Great Job” (GJ) button to click. Once the button is clicked, this pretty much concluded the minimum transaction for thanking a Provider. The GJ icon may, for a second, show a checkmark on it, before moving to the next screen.

It is important to note that the only part where the Customer delays a possible line behind her/his, is when she scans the Provider's QR code. All the rest can be done as she walks to her car or goes about her other business. To avoid even that slight delay, the customer may be first presented with the provider search screen 200H instead and have the option to choose to scan the provider QR code.

FIG. 2H is a screenshot of an exemplary list screen 200H showing a list of providers (i.e., the first users) from which the second user can choose for providing gratitude feedback, in accordance with an embodiment of the present disclosure. This screen is an alternative to the Scan QR Code screen 200G. The gratitude feedback management application 108 lists the people who are at various businesses nearby, with the option of search by name. The places nearby slider shoes the geo-located place in the middle and when selected, this logo may be shown in color, while the other on the list are shown in grayscale. Once selected, the list below will be populated with provider members or first users registered with the gratitude feedback management application 108 who are working currently at the selected place. The second user can choose one of them to thank them. The interface 200H may show only first name, image etc. The places nearby is a horizontal slider on the interface 200H. The interface 200H may list the nearby workplaces in a predefined distance radius.

In one embodiment of the present invention disclosure, FIG. 2I is a screenshot of an exemplary Great Job (GJ) gratitude giving screen 200I for one of the first user or provider members, in accordance with an embodiment of the present disclosure. As soon as the QR code is scanned, or as soon as a provider member is selected from the list on screen 200H, as shown in FIG. 2H, the Customer is presented with the information of the Provider member i.e., the first user, to make sure that they are indeed thanking the right person, and already with the big “Great Job” button to click. Once the button is clicked, this pretty much concluded the minimum transaction for thanking a provider member. The GJ icon may, for a second, show a checkmark on it, before moving to the next screen.

It is important to note that the only part where the Customer delays a possible line behind his/her, is when the customer scans the Provider member's QR code. All the rest may be done as the customer walks to his/her car or go about his/her other business. The screen 200I may be a first screen in the Great Job/thanking process. It may be the only screen, if the user wants to finish there. The customer may see that the information matches the person he/she wishes to thank and then thank them, by pressing the Great Job button. A checkmark may appear on the large Great Job symbol and after that the screen 200I moves to the next screen of FIG. 2J. The Great Job action is recorded once the person clicks on the GJ button. The Back button takes the user to the previous screen.

In some embodiments the users' (i.e., the first user 112 and the second user 116) devices 102 may use Near Frequency Communication type methods (e.g., NFC) to connect between each other and achieve the identification of the first user 112 by the second user 116 without the need for a search or scanning a QR code.

FIG. 2J is a screenshot of an exemplary additional Great Job gratitude giving screen 200J where the second user 116 (i.e., the customer) may click any of the 3 additional, more specific, category GJ gratitude icons/buttons, in accordance with an embodiment of the present disclosure. Once the GJ icon/button on screen 200I is clicked, the Customer is presented with the screen 200J, which will let her, if she so desires to provide additional, optional category gratitude feedbacks. The customer may drop it here and close the app or click the “Done” button, or the customer may provide more gratitude feedbacks, including the option to leave a personal message to the provider.

On this screen the customer may choose to give the provider more specific category “Great Job” gratitude feedbacks as detailed on the screen. The Customer may now click any of the three (3) additional GJ gratitude feedbacks: Friendly, Professional (i.e., Knowledgeable) and Prompt (i.e., Efficient). The click may be a toggle button. A checkmark may appear and disappear with every click. The symbols may be toggle buttons. The user may choose to toggle between ON (GJ symbol with checkmark on it) and OFF (GJ symbol only). The additional three gratitude feedback buttons may not include any text, and may be represented by corresponding icons, to be colored when ON and only drawn when OFF.

Once either clicking on “Done” to conclude the session, or clicking on the “Leave Message” button, requesting to leave a message, the gratitude feedbacks are saved in the Provider's account and all the counters are updated. Each gratitude feedback may be followed by a notification on the Provider's smartphone, smart watch, web notifications, etc. In some embodiments, the gratitude feedback management application 108 may send all the notifications and digest e-mails to the provider members and Customer. In some embodiments, the second user 116 (i.e., the customer) may receive a read notification from the gratitude feedback management application 108 when the first user 112 has seen the feedback provided to the first user 112 by the second user 116.

The next step is the “Leave Message” screen as shown in subsequent figures, but leaving a message is not compulsory. The customer may choose to finish by selecting or pressing the “Done” button at any point. If the customer closes the application or leaves it at this stage, the previous screen's GJ action was already recorded, but nothing more would be recorded.

FIG. 2K is a screenshot of the exemplary additional, optional, more specific, category Great Job (GJ) gratitude feedbacks giving screen 200K where the second user 116 can click the “Done” button or can leave a personal message, in accordance with an embodiment of the present disclosure.

The Customer Personal Note screen may look like the screen 200M and may include a “cancel” or “Back” button, if the Customer changed his/her mind and does not want to leave a personal note anymore. This screen may also include a selection of stickers, GIFs and other images to choose from, to construct the message to be sent by the customer to the provider member.

FIG. 2L is a screenshot of the exemplary Great Job (GJ) gratitude giving screen 200L that appears when the second user 116 tries to close without selecting done or leave a message tab, in accordance with an embodiment of the present disclosure. This screen or message may appear when the customer made changes to the toggle buttons but then hit the back button at the top left of the screen 200K.

Once either clicking on the “Done” button or requesting to leave a personal message, the gratitude feedbacks are saved in the Provider's account and all the counters are updated. Each gratitude feedback may be followed by a notification on the Provider's smartphone, smart watch, web notifications, etc. There will be a separate chapter about all the notifications and digest e-mails that the Provider and Customer may receive from gratitude application 108.

FIGS. 2M-2O illustrate screenshots of the exemplary second user's personal note/message screen 200M, 200N, and 200O, where the second user 116 may leave a message for the provider member (i.e., the first user 112). The second user 116 can leave a message for the first user 112 on the screen 200M, the gratitude feedback management application 108 then sends this message to the first user (i.e., the provider member) and may also post it to the social feed of the first user 112, if the first user so elected. Once the message is sent, the gratitude feedback management application 108 triggers a notification on the recipient's (i.e., the first user's) device and the message may appear on his/her Me and Friends feed. The recipient may delete the message, and this will delete the message from all the feeds.

Further, as shown in the personal note's screen 200M, a cancel or a back button is provided. If the customer (i.e., the second user 116) changes his/her mind and does not want to leave a personal note anymore, the customer may cancel or go back by pressing the respective button. On pressing the back button and after making changes to the message, the screen 200O opens up asking the user to confirm if he/she would like to continue or not.

FIG. 2P is a screenshot of the exemplary daily activity summary screen 200P of a user who is at least a provider member, (e.g., the first user 112), in accordance with an embodiment of the present disclosure. The screen 200P is a default page of the activity section. Clicking on each of the bars may show details of the specific gratitude type received in the category selected. Clicking on the “Month” label (e.g., January) will show the calendar and the user can choose whichever day of activity the user 102 wants to view.

FIG. 2Q is a screenshot of the exemplary activity screen 200Q of a user who is both a provider member (i.e., the first user 112), as well as a customer (i.e., the second user), illustrating both giving thanks and receiving thanks activity attributes, in accordance with an embodiment of the present disclosure.

FIG. 2R is a screenshot of another exemplary activity screen 200R of a provider member (i.e., the first user 112), illustrating detailed hourly activity in a given day (e.g., Today), in accordance with an embodiment of the present disclosure. The user may move to previous days via the screen 200R. The screen 200R may show a selected category only. The user may move from day to week to month to year. The gratitude feedback management application108 may also show all kinds of statistics here, like trends, averages, percentile, etc.

FIG. 2S is a screenshot of the exemplary activity screen 200S of a provider member, (i.e., the first user 112), illustrating detailed week activity, in accordance with an embodiment of the present disclosure.

FIG. 2T is a screenshot of the exemplary activity screen 200T of a provider member (i.e., the first user 112), illustrating detailed monthly activity, in accordance with an embodiment of the present disclosure.

FIG. 2U is a screenshot of the exemplary activity screen 200U of a provider (i.e., the first user 112) illustrating detailed yearly activity, in accordance with an embodiment of the present disclosure.

FIGS. 2V-2W is a screenshot of the exemplary “Friends” social screen 200V and 200W listing social networks friends of a user (i.e., the first user 112 or the second user 116), in accordance with an embodiment of the present disclosure. The screen 200V may be the default screen when the social button is pressed. This screen shows all the connections of the user from his/her connected social networks. A user can like an item, just like on Instagram. Awards and messages are also shown here.

The screen 200W shows what it looks like when any user likes an item.

FIG. 2X is a screenshot of the exemplary “Me” social screen 200X, listing all activity related to the user (i.e., the first user 112 or the second user 116), in accordance with an embodiment of the present disclosure. The screen 200X shows all the gratitude feedbacks received or given by the user including award badges and messages. A user's friends on his/her connected Social Networks (e.g., Facebook, LinkedIn, etc.) may like an item, just like on Instagram. The user may delete text messages that were left for him/her and these messages would be deleted from all feeds of all users in the application.

FIG. 2Y is a screenshot of the exemplary “Me” social screen 200Y showing a message delete confirmation, in accordance with an embodiment of the present disclosure. This screen 200Y may show a warning to confirm that the user really wants to delete a certain message.

FIG. 2Z is a screenshot of the exemplary social “Me” screen 200Z after a message has been deleted, in accordance with an embodiment of the present disclosure. The screen 200Z shows the message was actually deleted.

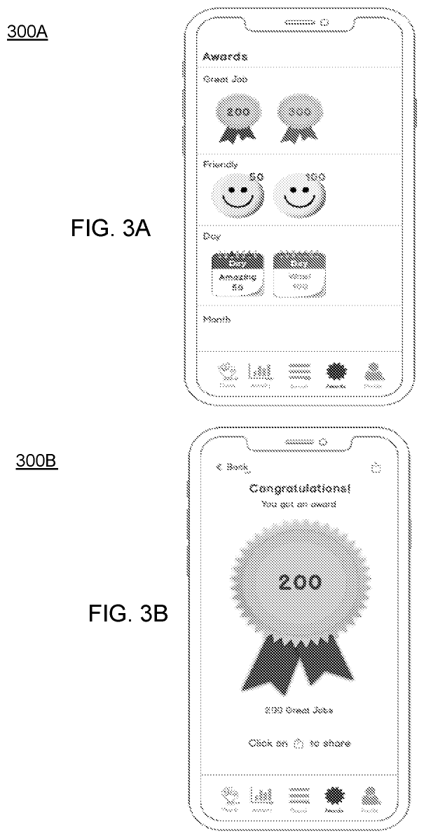

FIG. 3A is a screenshot of an exemplary award badges screen 300A, in accordance with an embodiment of the present disclosure. The screen 300A may show the award badges of the first user 112 organized by topic: Great Job, Prompt (i.e., Efficient), Friendly, Professional (i.e., Knowledgeable), Day, Month, Year. Each section may show all the badges that the user got under each category and also the next badge that the user is on his/her way to achieve, grayed. The gratitude feedback management application 108 keeps count of the feedbacks that each user gives or received, in each of the categories and over each period of time (e.g., Day, Month, Year) and keeps configurable application parameters for when to issue an Award Badge to a user (i.e., the user will receive an “Amazing Week” award badge in the “Friendly” category each time they reach 150 “Friendly” Great Job gratitude feedbacks in any given week). The user can click on each award badge and get a full screen view of the award badge, with the option to share. When a new badge arrives, a notification may be sent to the user, again, with the ability to share the badge and the user may choose to post award badges automatically to their connected Social Networks. The user can scroll to see the previous ones, etc. If there are no award badges received under any category (for example, day), then the first one to be received will be shown in gray color or any specific color.

FIG. 3B is a screenshot of an exemplary full screen 300B view of a badge of the award screen with the option to share it, in accordance with an embodiment of the present disclosure.

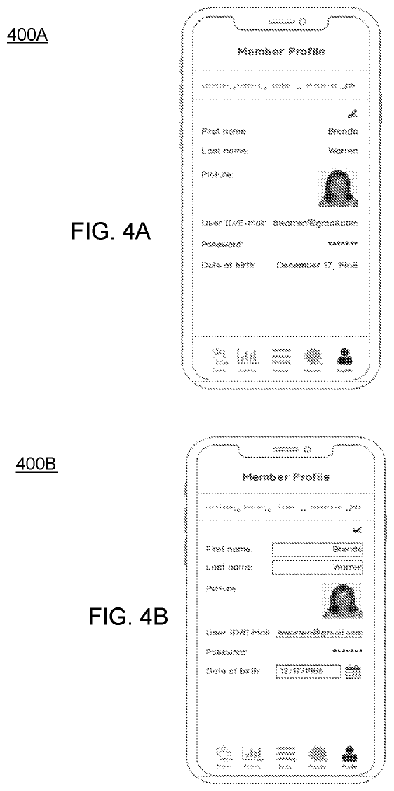

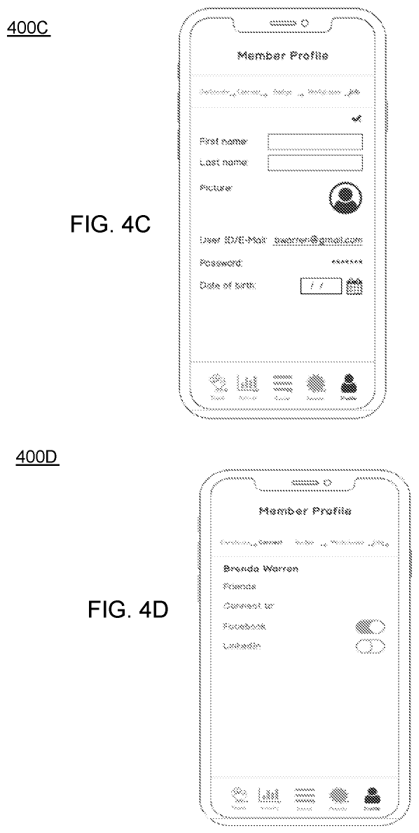

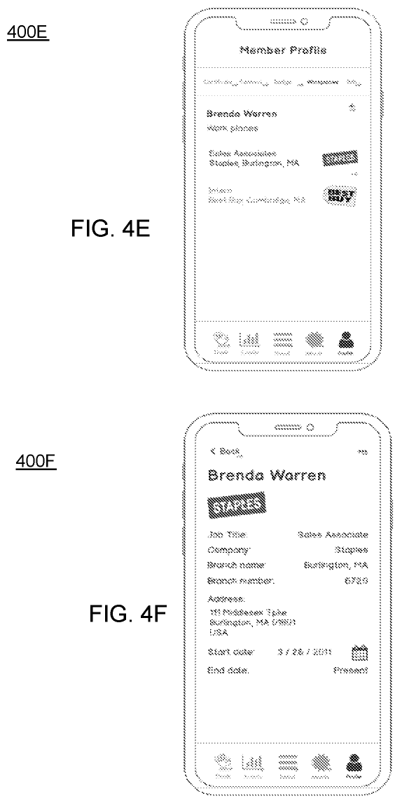

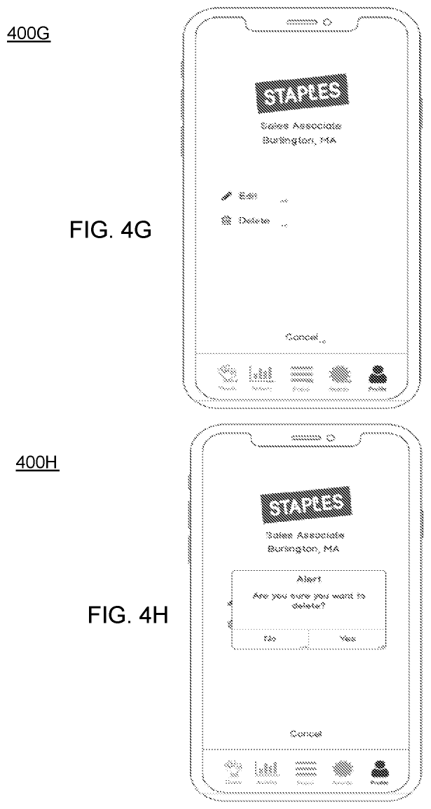

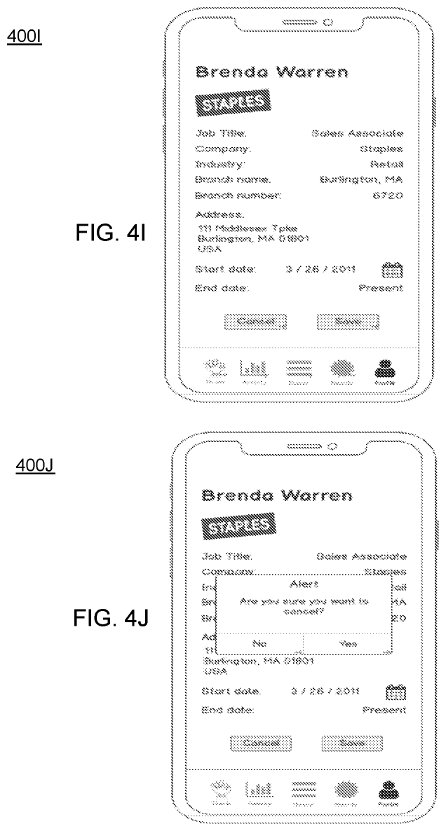

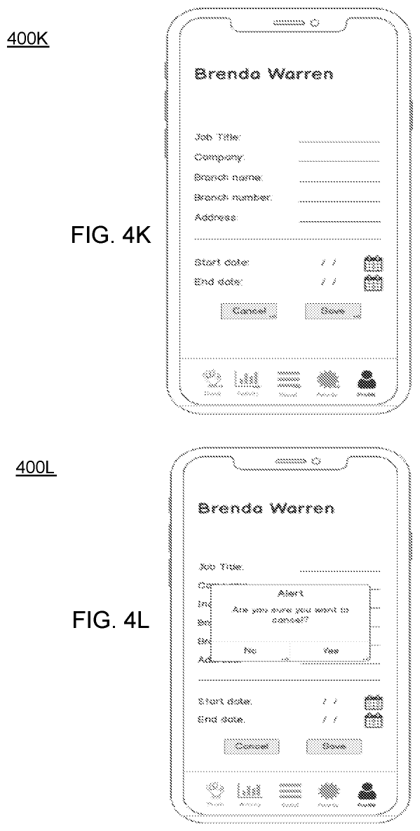

FIG. 4A is a screenshot of an exemplary member profile Info (i.e., Information) screen 400A for a user such as a provider member (i.e., first user 112) or customer (i.e., second user 116), in accordance with an embodiment of the present disclosure. The screen 400A is the member profile Info screen. The profile section may have sub-sections, which are reachable via the menu items at the top of the screen. The gratitude feedback management application 108 may check and if the age of the user, as reflected by the DOB, is less than 13 years, the gratitude feedback management application 108 may not allow them to use the application. The gratitude feedback management application 108 can also check as to whether certain screens can be entered if there is no current workplace. For example, if there is no current active workplace, then there is no workplace badge that can be displayed. As for the certificate, it is different. As long as there is a history of workplaces and GJs gratitude feedbacks that a first user 112 received, then the certificate can be created and displayed.

FIG. 4B is a screenshot of an exemplary member profile edit screen 400B for a user, in accordance with an embodiment of the present disclosure. The user can edit his/her information. The gratitude application 108 may perform same checks as before, to make sure age is above minimum, etc. The user can change email address, etc. the gratitude feedback management application 108 can check for correctness of the email address. The gratitude feedback management application 108 in some embodiments may send an email to activate the account or profile or to verify the e-mail address.

FIG. 4C is a screenshot of an exemplary new member profile screen 400C for a new user registering with the gratitude feedback management application 108, in accordance with an embodiment of the present disclosure. The screen 400C may be a first screen that the user will see when the new user registers with the gratitude feedback management application 108. All checks for validity may also be made by the gratitude feedback management application 108. The gratitude feedback management application 108 may send an activation email. In some embodiments, a profile picture, a workplace, may or may not be essential.

FIG. 4D is a screenshot of an exemplary member profile Connect screen 400D for a user to connect one or more of their social networks, in accordance with an embodiment of the present disclosure. The user can connect to social networks. This is for the Friends section in the social part of the application or the gratitude feedback management application 108. Phone's standard process may be used. In order for a user to see their social network friends' activity in the Friends feed, both the user and other friends may need to enable that specific network on this screen 400D. If the user log-in with Facebook account, then this may automatically enable FB on this screen 400D.

FIG. 4E is a screenshot of an exemplary member profile Workplaces screen 400E showing a number of workplaces of the first user 112, in accordance with an embodiment of the present disclosure. The screen 400E is the user's workplaces' main viewing screen. Here, the user can see all his/her current and past workplaces. The past workplaces may be grayed, and current ones are colored. The user can click on each one of them and view them and edit them. Clicking on the + symbol, the user can add a new workplace (either past or current).

FIG. 4F is a screenshot of an exemplary specific workplace view screen 400F showing details of one specific workplace on a selection by a first user 112, in accordance with an embodiment of the present disclosure. This screen 400F appears when a user clicks on one of the workplaces on screen 400E. The menu shown on the screen 400F may allow the user to edit or delete a workplace.

FIG. 4G is a screenshot of an exemplary workplace options screen 400G for a specific workplace where the user can edit or delete the workplace, in accordance with an embodiment of the present disclosure. The options screen 400G is a screen for a specific workplace. The user can choose to edit or delete a workplace. If choosing to delete, a confirmation window may pop up.

FIG. 4H is a screenshot of an exemplary workplace delete screen 400H for a specific workplace to confirm deletion of a workplace. The screen 400H shows a confirmation pop-up before deleting the workplace.

FIG. 4I is a screenshot of an exemplary workplace edit screen 4001 for editing a specific workplace. The edit screen 4001 for a specific workplace. The user can save or cancel. Cancel after changes are made triggers a popup window.

FIG. 4J is a screenshot of an exemplary workplace edit cancel screen 400J to cancel editing of a specific workplace. The screen 400J may show a popup making sure that the user wants to discard all changes before canceling edit of a workplace.

FIG. 4K is a screenshot of an exemplary workplace add screen 400K for adding a new workplace. The screen 400K may be a new workplace screen. The gratitude feedback management application 108 may perform various checks. The user can choose “Present” as the end date. Cancel after input made triggers popup.

FIG. 4L is a screenshot of an exemplary workplace add cancel screen 400L for canceling adding of a new workplace. Popup in case new workplace input made and user wants to cancel.

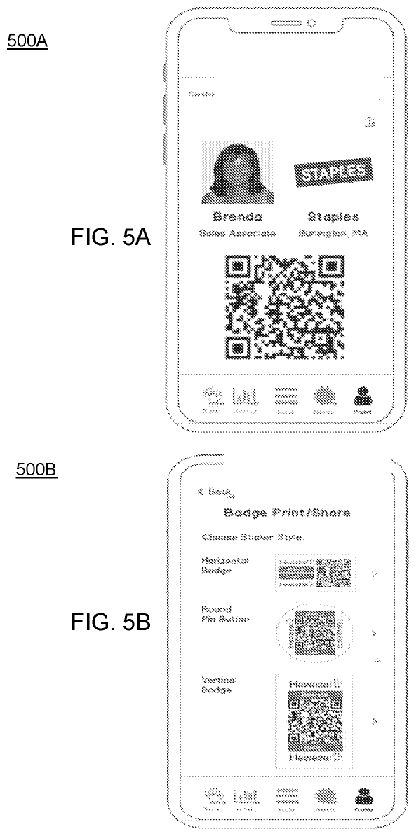

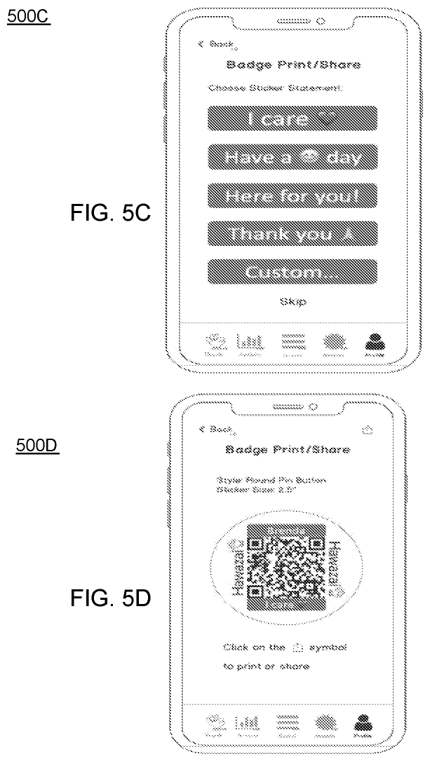

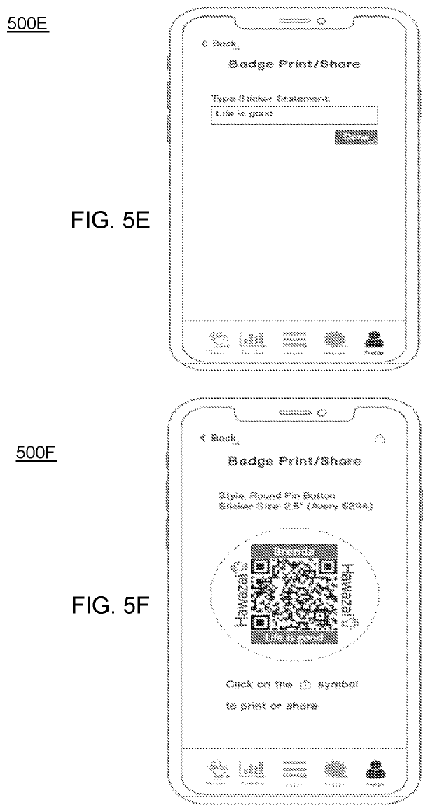

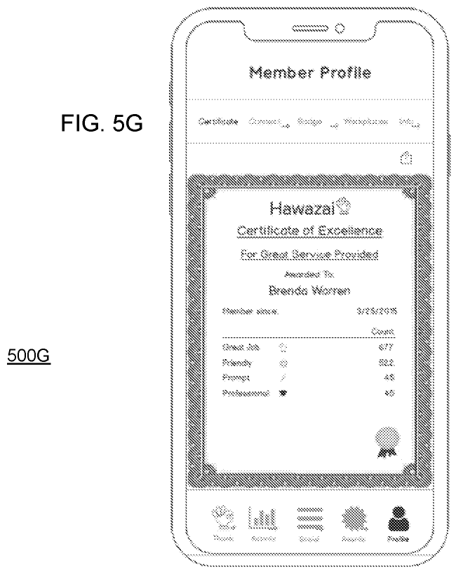

FIG. 5A is a screenshot of an exemplary member ID badge display screen 500A, displaying the user's workplace ID badge on the gratitude feedback management application 108. This is what first user 112 may show to the second user 116 (i.e., the customer) when the customer wants to thank the first user. From this screen 500A, the user can choose to print the ID badge on a sticker, which they can place on their uniform or a badge that they can place inside a badge holder. Sizes and styles of badges and stickers are detailed in the next screen.

FIG. 5B is a screenshot of an exemplary print/share ID badge screen 500B for selecting a style of badge when the user wishes to print their ID badge. When the user wishes to print his/her ID badge, the screen 500B appears. The user can choose between three designs/styles. In an embodiment, the horizontal badge or the size of the printed badge may be 3.375 inches wide and 2.125 inches high. The screen may show a round pin button. Diameter of the printed badge may be 2.5 inches. Vertical badge—size of the printed badge may be 2.125 inches wide and 3.375 inches high. Mockups are displayed with a default statement and first name of first user 112. The screen 500B may not show the full name of first user 112.

FIG. 5C is a screenshot of an exemplary print/share ID badge choose statement screen 500C for enabling the user to select a sticker statement for the badge. After choosing a style the user may choose their badge or sticker statement. The user can choose to skip and not show a statement. In that case, the statement bar will be blank but will still appear.

FIG. 5D is a screenshot of an exemplary print/share badge preview screen 500D for enabling the user to preview the badge with a statement prior to printing. A preview is shown right before printing/sharing with information on the size of the printed sticker.

FIG. 5E is a screenshot of an exemplary print/share ID badge custom statement screen 500E for enabling the user to enter a custom statement for the badge. The user may type his/her own sticker statement on the screen 500E. The statement may be limited to 15 characters, including blanks, to make sure it appears aesthetically well on the badge. Emoticons may also be used in the custom statement.

FIG. 5F is a screenshot of an exemplary print/share ID badge preview screen 500F for enabling the user to preview the ID badge with the custom statement prior to printing. Preview of the badge with the custom statement is shown on the screen 500F.

FIG. 5G is a screenshot of an exemplary certificate screen 500G of the user like a provider member. The certificate shown is a certificate of excellence in customer service provided by the user. In one embodiment, the information displayed on the certificate may show the aggregate number of the GJ gratitude feedbacks that the user received since they joined the gratitude feedback management application 108 may serve as audited, certified proof of the level of service provided by the first user 112. The user can then print or share the certificate shown on the screen 500G with friends on Social Networks or with potential future employers, who may use the gratitude feedback management application 108 as the “gold standard” for measuring and evaluating individual customer service performance by its provider member users. In some embodiments, the certificate may include percentiles according to the regions and industries or another customer service calculated score.

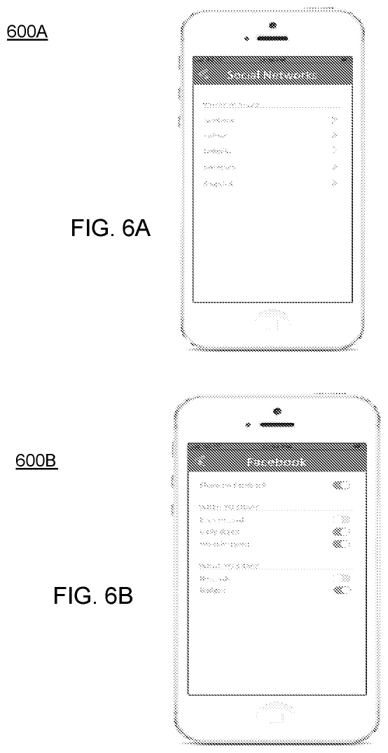

FIG. 6A is a screenshot of an additional exemplary social networks screen 600A of the user like a customer or a provider member. The first user 112 also referred as a provider or provider member can show off different events on their social networks—Facebook, Twitter, LinkedIn and others. They can decide which network to connect to and what to publish to their timelines. For example, they can decide to publish their weekly rewards on Facebook and each GJ reward they get, right on Twitter. Finally, they can decide to publish their badges on a social network like Instagram, as they arrive. Further, each social network may have its different parameters. When a network is chosen, its page is opened and the user chooses his/her sharing preferences. If the OS does not have the login info, the user may be presented with the user login information and permissions may be granted.

FIG. 6B is a screenshot of the exemplary specific social network screen 600B when a specific social network is selected. When a network is selected, the specific network screen is displayed as shown in the screen 600B. The user may choose to automatically share or not to share info on any specific Social Network. If the user chooses not to share on a specific social network, then the toggle buttons below will not appear. If login information is missing, the app will ask for it. The info may be stored in a database 101 of the gratitude feedback management application 108 or may only be stored in the app. Here, the user may decide when to share on each specific network. Whether per each event that occurs, or on a daily basis, or weekly, or monthly. Now that the user knows “when” to share, the user can decide “what” to share—each gratitude received, the award badges, or both. It may be also decided to separate between Customer events and Provider member's events.

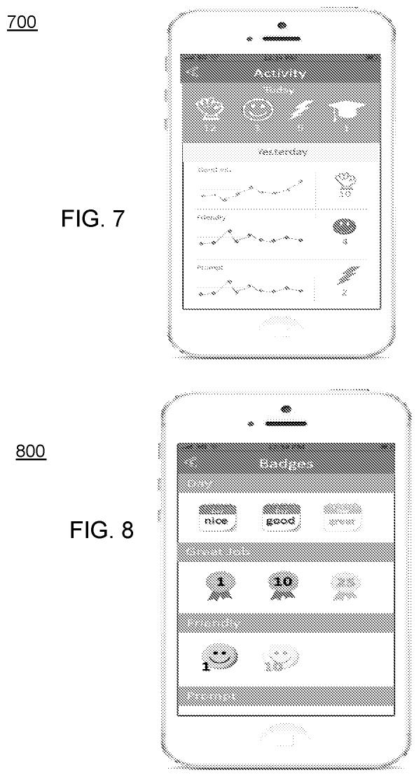

FIG. 7 is a screenshot of an additional exemplary activity screen 700 where the user can view their activity, both as a provider and as a customer. This is where the user can view their activity, both as a Provider member and as a Customer. The screen may look like this screen 700 for the Provider member mode. The section at the top of the Activity screen shows the number of awards received today, in general and in each of the specific 3 categories. Then the user can scroll down and see each passing day, with the number of awards received, as well as a graph of previous X days.

FIG. 8 is a screenshot of an additional exemplary award badges screen 800 where the user can view all the award badges collected by him/her. When a user reaches a certain number of GJ gratitude feedbacks, they earn an award badge. There may be many different badges for various aspects of the application and Provider performance, as well as for activity level, from the Customer standpoint. The award badges screen may look like the screen 800. Each category may have a section on the Award Badges screen. The user scrolls the screen to reach the categories he/she can't see. The last award badge in each category is always grayed and shows the next award badge to be earned. This may be the first one shown, with a progress bar showing progress towards that badge or a small one below the award badge. Award badges can be for a number of gratitude feedbacks of any certain kind, throughout the life of a user in the application or for a number of badges for a certain amount of time—day, week, month and year.

The user can sign out at any time. In that case, the application may not sign the user in automatically, when the application is opened, and the Sign-In screen will be presented. Once the sign-in is done again, the user may be signed in automatically again. Examples of award badges are detailed in FIG. 8.

Award badges for type of day may include but are not limited to: Not Bad Day—3 GJ, Nice Day—5 GJ gratitude feedbacks in one day (like in the above examples, can be done for each one of the 3 sub-categories); Good Day—10 GJ gratitude feedbacks in one day; Sweet Day—15 GJ in one day; Great Day—20 GJ gratitude feedbacks in one day; Amazing Day—50 GJ gratitude feedbacks in one day; Wow! Day—100 gratitude feedbacks in one day. Same can be done with week and month. The actual number of gratitude feedbacks needed to achieve each award may be system-configurable and may change according to the industry, location, and other parameters that may influence the expected pace at which a Provider may receive gratitude feedbacks over a certain period of time. Further, award badges can be awarded for breaking a personal record in a day, week and month, for each of the categories (general, friendly, professional (i.e., knowledgeable), prompt (i.e., efficient)). Award badges may be awarded as the user reaches system-configurable milestone numbers of GJ gratitude feedbacks received in each category, for example, when the user reaches 10, 25, 50, 100, 200, 300, 400, 500, 750, 1000, 1500, 2000, 2500, 3000, 5000, etc., as displayed in FIG. 8. Each category may have a topic and different badges for each milestone as shown in below Table 1:

| Milestone | General | Friendly | Prof. | Prompt |
|---|---|---|---|---|
| Topic | Mountains | Nice things | Tools | Vehicles |
| 10 | Sunset Peak, Hong Kong | Smiley | Pencil | Tricycle |
| 25 | Mount Wellington, | Flower | Ruler | Skateboard |
| | Australia | | | |
| 50 | Cascade Mountain, | Cupcake | Screwdriver | Rollerblades |
| | Canada | | | |
| 100 | Mt. Fuji, Japan | Heart | Solder | Bicycle |
| 200 | Matterhorn, Switzerland | Teddy Bear | Microscope | Scooter |
| 300 | Kilimanjaro, Tanzania | Robot | Tool box | Motorcycle |
| 400 | Denali, Alaska | Casper the | Drill | Car |
| | | friendly ghost | | |
| 500 | Nevado Tres Cruces, | Puppy | Jigsaw | Locomotive |
| | Chile | | | |
| 750 | Nanda Devi, India | Dolphin | Laptop | Hovercraft |
| 1000 | Broad Peak, | Sunshine | Helmet | Ship |
| | China/Pakistan | | | |
| 1500 | Makalu, Nepal | Rainbow | Tractor | Airplane |
| 2000 | K2, China/Pakistan | Crown | Roller | Rocket |
| 2500 | Everest, Tibet | Reach for the | Crane | Spaceship |
| | | stars | | |
| Etc. | | | | |

The gratitude feedback management application 108 may provide another exemplary way of presenting the different award badge milestones (e.g., with a certain icon or a symbol), accompanied by a number of the milestone. For example, 10,000 times someone got the “Prompt” score would be a lightning bolt icon with the number 10,000 on it. Friendly can be a smiley and Professional can be an icon of a scholar hat or a briefcase.

The disclosed gratitude feedback management application 108 enables a plurality of users to register and create a profile on the gratitude feedback management application 108. The users may access the application via a computing device either via a website or a mobile application. The users may receive and give gratitude to other users connected to the gratitude feedback management application 108. The users may connect their profile to their social network accounts. The gratitude feedback management 108 may notify the users whenever they receive personal messages including gratitude message. The gratitude feedback management application 108 may assign an award badge to the users based on the gratitude feedbacks received. Further, the gratitude feedback management application 108 manages all the award badges earned by the users in one place (i.e., their profile). The gratitude feedback management application 108 enables the users to share and show their profile or part of the profile (e.g., the award badges) with their friends or other users or potential employers (i.e., recruiters).

The disclosed methods and gratitude feedback management application 108 comprises mechanisms for avoiding frauds in giving gratitude feedbacks. A fraud is defined as gratitude feedback given by a customer to a provider member (e.g., a waiter, a customer serving person, etc.), outside of the basic scenario of the provider member providing service to the customer. Two friends, who wish to help each other obtain high scores, as if they are excellent service providers, can do this, for example. In some embodiments, an individual provider member cannot receive thanks from the same customer twice in each day (or week, or a system-configurable period of time). In some embodiments, using BI algorithms, the network or the gratitude feedback management application 108 in the network may detect fraudulent behavior of certain individuals, whether they are provider members or customers. Once fraud has been detected, there may be certain procedures in place to deal with the delinquents.

In some embodiments, the gratitude feedback management application 108 may provide additional attributes on a profile of a user who can be a customer or a service provider/provider member such as attributes to signify that the user is providing a lot of feedback on the platform. Much like user-forum application award members/users in a forum for many posts and they promote them from rookie to expert, etc.

If the name of the workplace can be found in the database 101 of the gratitude feedback management application 108 or may be found on publicly available databases such as that of Yelp, as an example, then the provider members/providers should be able to select a workplace from the database 101. If not, the provider members/providers can manually enter their workplace information. The gratitude feedback management application 108 may store the workplace information in its database 101. The gratitude feedback management application 108 may save past workplaces with the achieved GJ gratitude feedbacks for each provider member user. The past companies' records may also include the last month/year of employment there.

In some embodiments, the gratitude feedback management application 108 is configured to identify the workplace information automatically, if the person is at that workplace at the time of adding the workplace. There may be a button/option for the application to suggest the information and fill it out automatically by using the location services of the device the user is using for registration.

In some embodiments, the gratitude feedback management application 108 is configured to maintain a history of some kind, to keep for each member all the gratitude feedbacks that they gave as a customer and all the gratitude feedbacks that they received as provider members. In some embodiments, the gratitude feedback management application 108 is configured to analyze the stored information.

In some embodiments, the gratitude feedback management application 108 is configured to provide total score options comprising the Star/Smiley type in which each time the customer thanks the provider member, they give them a star (e.g., a GJ symbol). There are no differences between stars, so there are not “less” or “more” stars the provider can get. It is either a yes or a no. The number of stars that a provider gets over time represents how good they are. The gratitude feedback management application 108 then displays the number of stars a provider member got. As the provider member reaches certain numbers of stars, they can collect different types of award badges, related to how many stars they collected, whether over time or in general.

In some embodiments, the gratitude feedback management application 108 enables the users to provide additional feedbacks and thanks. One general gratitude feedback only is a good start, and should be mandatory in any feedback session, but if the customer would be so inclined, they may provide just a bit more feedback via the gratitude feedback management application 108. Not too much, so as to not deter the customer from going that extra mile, but enough to build a more detailed service profile of our provider member.

In some embodiments, the gratitude feedback management application 108 provides feedback to a provider member for being Friendly. This is where the customer may give gratitude feedback relating to the provider member's friendliness, courtesy level, or kindliness. It is about how pleasant they were, or how nice the provider member was when he/she provided the service.

In some embodiments, the gratitude feedback management application 108 may allow the customers to give gratitude feedback to the provider member for being Prompt (i.e., efficient) with the service provided to the customers. The customers can give the provider members gratitude feedback for their promptness (i.e., how efficiently they provided the service).

In some embodiments, the gratitude feedback management application 108 may allow the customers to give gratitude to the provider member for being Professional (i.e., knowledgeable), for being an expert in what they do, for being knowledgeable and providing service which is professional to the customers. This is about how proficient the provider member was when he/she provided the service. For example, did the waiter know the items on the menu well? Did the Best Buy sales associate know her way around the various TVs in the store, and helped the customer choose the one that would fit his needs best?

Considering the additional information collected from the customer per any given interaction, in some embodiments, the gratitude feedback management application 108 may award the provider members with different award badges, representing individual achievements, related to the 3 types of areas they can excel at. They can display all their badges on their gratitude application 108 web page and post them to their social network feeds.

In some embodiments, the provider member profile may maintain 4 scores: General Score, Friendliness Level, Proficiency (i.e., Knowledge) Level and Promptness (i.e., Efficiency) Level. In some embodiments, the gratitude feedback management application 108 may enable the users to decide—what the age is for any given score. Is it a year? Is it their employment with a certain company? Is it a lifelong score? This can also be a combination of both the current workplace, with the achievements earned for that specific workplace and also a general score, which is a lifelong score.

In some embodiments, the gratitude feedback management application 108 may enable a provider member to decide whether he/she would like to start a clean slate and if they would like to, how many times they can do that. Letting provider members “reset” their history on the gratitude feedback management application 108 lets them improve and achieve better in their current workplace. The gratitude feedback management application 108 may show the “Member Since” date of the users on their certificate of service excellence mentioned earlier, so that the current score of each provider member user may be combined with the “Member Since” date to reflect a weighted score of the user, based on those two parameters (score and start date). Resetting the user's start date may be an important attribute, as it lets any user start from fresh at any time and gives them a chance to excel, no matter what their past was on the system.

In some embodiments, the gratitude feedback management application 108 may provide the provider member with a link to a History repository, which contains all the gratitude feedback instances that were given by customers over time. The provider members can possibly get statistics of their service performance over time, for a given workplace, given category, etc. This data can be then processed on a larger scale for a branch, region, company, etc.

The gratitude feedback management application 108 may be configured to analyze and provide company level, anonymous, BI analytics and reports. The gratitude feedback management application 108 may store within it a lot of information to analyze and can produce valuable reports for Companies, across regions, countries, states and over periods of time. Some examples would be for McDonalds to be able to identify which restaurants in a certain region provide the best service to its customers as a whole. In other words, which restaurant in the McDonalds chain has the best service providing employees, which reflects on best managers. For example, if a manager was replaced recently and after 3-6 months there is a spike in the number of gratitude feedbacks that a branch/restaurant is getting, it may mean a lot about the new manager. Same goes for measuring regions or districts. Good regional management of Best Buy would trickle down to service level and would be seen as an “island” of great service of the majority of the stores in a certain region over time.

This, of course, can create internal competition within the regions and among the branches, if the Company recognizes the measurements done by the gratitude feedback management application 108.

Service level can change over time and that can be measured globally, regionally or even locally, for any given Group or Company.

The gratitude feedback management application 108 may act as an extremely valuable tool for Companies. The gratitude feedback management application 108 can alert companies of their consistently best regions, branches and employees and the Companies can in turn compensate those as well and publish their achievements across the company Intranet.

The disclosed method is very simple and easy to use by customers for providing gratitude feedbacks to provider members. The method may start with the Customer receiving service from the Provider. After receiving the service, the Customer thanks the Provider for their high level of service. The gratitude feedback giving process may be of single, dual or triple stages. The gratitude feedback management application 108 may start from the default screen the user left it at. So, if a user used the app last as a provider member (e.g., the app displayed their ID badge screen 500A), the app or the gratitude feedback management application 108, when started, may start from the that same default screen of the provider member user. If the app was used last as a Customer, the application may start in the default screen of the Customer type user (e.g., the QR scanning screen 200D or the Provider search screen 200H).

Further, the users can provide a link to access their profile on their resume, or activate a feature in the application 108 to allow recruiters to view their achievements and contact them, so that this can help them to obtain better roles in future.

In some embodiments, the gratitude feedback management application 108 gives a different set of award badges to the user who is the Customer, for giving gratitude feedbacks to Providers. Award badges are delivered to the user via notifications on his/her smart phone, his/her smart watch, via e-mail, digests and on the Award Badges screen and web pages.

In an exemplary scenario, the gratitude feedback management application 108 is running in a smart watch, the provider member user can access the gratitude feedback management application 108 on his/her watch and immediately show the QR code on the screen, for the customer to scan. The user will receive his/her notifications on the watch as well.

The gratitude feedback management application 108 may enable the user to set goals to reach each day for each of the categories. The watch can show the user where he/she is in each category.

In an exemplary embodiment, the gratitude feedback management application 108, using the location services option enabled on the customer, or second user 116's device 102, may alert the second user 116 after he/she has entered a customer facing business (e.g., a restaurant, a store, a coffee shop, etc.), has stayed there for a configurable amount of time and has then left the place, with a notification question of whether the second user 116 wishes to give gratitude feedback to any provider member, first user 112, at the business place they just left. The second user would have to enable location services to be active “even when the app is not being used”, as many users do with many applications nowadays.

The present disclosure also provides a system to undertake the method disclosed in this disclosure in entirety or in parts as and where applicable.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

21. A method for providing descriptive gratitude feedback from a customer service recipient individual to a customer service provider individual, the method comprising:
identifying the customer service provider individual;
prompting the customer service recipient individual to enter at least one type of the descriptive gratitude feedback for the customer service provider individual;
receiving the at least one type of the descriptive gratitude feedback from the customer service recipient individual for the customer service provider individual; and
based upon identification of the customer service provider individual, transmitting the at least one type of the descriptive gratitude feedback to the customer service provider individual.

22. The method of claim 21, wherein the at least one type of the descriptive gratitude feedback comprises at least one icon.

23. The method of claim 21, further comprising, based upon a time at a geographic location of the customer service recipient individual equaling at least a configurable time period, prompting the customer service recipient individual to indicate whether the customer service recipient individual wants to provide the at least one type of the descriptive gratitude feedback to a potential customer service provider individual.

24. The method of claim 21, wherein identifying the customer service provider individual comprises receiving an identifier configured to identify the customer service provider individual.

25. The method of claim 21, wherein identifying the customer service provider individual comprises receiving a selection of the customer service provider individual by the customer service recipient individual from a list of customer service provider individuals employed by an entity geolocated by the customer service recipient individual.

26. The method of claim 21, wherein prompting the customer service recipient individual to enter the at least one type of the descriptive gratitude feedback comprises providing the customer service recipient individual with a selection of predefined categories of descriptive customer gratitude feedbacks,
wherein receiving the at least one type of the descriptive gratitude feedback from the customer service recipient individual comprises receiving a choice by the customer service recipient individual of at least one customer service category.

27. The method of claim 21, wherein prompting the customer service recipient individual to enter the at least one type of the descriptive gratitude feedback comprises prompting the customer service recipient individual to enter a message configured to be transmitted to the customer service provider individual;
wherein receiving the at least one type of the descriptive gratitude feedback from the customer service recipient individual comprises receiving the message configured to be transmitted to the customer service provider individual from the customer service recipient individual.

28. The method of claim 21, further comprising receiving a badge awarded to the customer service recipient individual based upon a number of descriptive gratitude feedbacks, provided to customer service provider individuals and which is configured to be displayed.

29. An apparatus comprising: processing circuitry configured to:
identify a customer service provider individual;
prompt a customer service recipient individual to enter at least one type of descriptive gratitude feedback for the customer service provider individual;
receive the at least one type of the descriptive gratitude feedback from the customer service recipient individual for the customer service provider individual; and
based upon identification of the customer service provider individual, transmit the at least one type of the descriptive gratitude feedback to the customer service provider individual.

30. The apparatus of claim 29, wherein the at least one type of the descriptive gratitude feedback comprises at least one icon.

31. The apparatus of claim 29, wherein the processing circuitry is further configured to, based upon a time at a geographic location of the customer service recipient individual equaling at least a configurable time period, prompt the customer service recipient individual to indicate whether the customer service recipient individual wants to provide the at least one type of the descriptive gratitude feedback to a potential customer service provider individual.

32. The apparatus of claim 29, wherein identify the customer service provider individual comprises receive an identifier configured to identify the customer service provider individual.

33. The apparatus of claim 29, wherein identify the customer service provider individual comprises receives a selection of the customer service provider individual by the customer service recipient individual from a list of customer service provider individuals employed by an entity geolocated by the customer service recipient individual.

34. The apparatus of claim 29, wherein prompt the customer service recipient individual to enter the at least one type of the descriptive gratitude feedback comprises provide the customer service recipient individual with a selection of predefined categories of descriptive customer gratitude feedbacks;
wherein receive the at least one type of the descriptive gratitude feedback from the customer service recipient individual comprises receive a choice by the customer service recipient individual of at least one customer service category.

35. The apparatus of claim 29, wherein prompt the customer service recipient individual to enter the at least one type of the descriptive gratitude feedback comprises prompt the customer service recipient individual to enter a message configured to be transmitted to the customer service provider individual;
wherein receive the at least one type of the descriptive gratitude feedback from the customer service recipient individual comprises receive the message configured to be transmitted to the customer service provider individual from the customer service recipient individual.

36. The method of claim 21, wherein the processing circuitry is further configured to receive a badge awarded to the customer service recipient individual based upon a number of descriptive gratitude feedbacks provided to customer service provider individuals and which is configured to be displayed.

37. A non-transitory computer readable medium storing a program causing at least one processor to execute a process for providing descriptive gratitude feedback from a customer service recipient individual to a customer service provider individual, the process comprising:
identifying the customer service provider individual;
prompting the customer service recipient individual to enter at least one type of the descriptive gratitude feedback for the customer service provider individual;
receiving the at least one type of the descriptive gratitude feedback from the customer service recipient individual for the customer service provider individual; and
based upon identification of the customer service provider individual, transmitting the at least one type of the descriptive gratitude feedback to the customer service provider individual.

38. The non-transitory computer readable medium of claim 37, wherein the at least one type of the descriptive gratitude feedback comprises at least one icon.

39. The non-transitory computer readable medium of claim 37, wherein the process further comprises, based upon a time at a geographic location of the customer service recipient individual equaling at least a configurable time period, prompting the customer service recipient individual to indicate whether the customer service recipient individual wants to provide the at least one type of the descriptive gratitude feedback to a potential customer service provider individual.

40. The non-transitory computer readable medium of claim 37, wherein identifying the customer service provider individual comprises receiving an identifier configured to identify the customer service provider individual.

41. The non-transitory computer readable medium of claim 37, wherein identifying the customer service provider individual comprises receiving a selection of the customer service provider individual by the customer service recipient individual from a list of customer service provider individuals employed by an entity geolocated by the customer service recipient individual.

42. The non-transitory computer readable medium of claim 37, wherein prompting the customer service recipient individual to enter the at least one type of the descriptive gratitude feedback comprises providing the customer service recipient individual with a selection of predefined categories of descriptive customer gratitude feedbacks;
wherein receiving the at least one type of the descriptive gratitude feedback from the customer service recipient individual comprises receiving a choice by the customer service recipient individual of at least one customer service category.

43. The non-transitory computer readable medium of claim 37, wherein prompting the customer service recipient individual to enter the at least one type of the descriptive gratitude feedback comprises prompting the customer service recipient individual to enter a message configured to be transmitted to the customer service provider individual;
wherein receiving the at least one type of the descriptive gratitude feedback from the customer service recipient individual comprises receiving the message configured to be transmitted to the customer service provider individual from the customer service recipient individual.

44. The non-transitory computer readable medium of claim 37, wherein the process further comprises receiving a badge awarded to the customer service recipient individual based upon a number of descriptive gratitude feedbacks provided to customer service provider individuals and which is configured to be displayed.
